(19) United States
(12) Patent Application Publication
(10) Pub. No.: US 2025/0253672 A1
(43) Pub. Date: Aug. 7, 2025

(54) Conductor Temperature Detector

(71) Applicant: Solaredge Technologies Ltd., Herzeliya (IL)

(72) Inventors: Yoav Galin, Raanana (IL); Meir Adest, Modiin (IL); Israel Gershman, Yehud (IL); Guy Sella, Bitan Aharon, IL (US); David Lachmann, Mevaseret Zion (IL); Bahat Shafat, Bat Hefer (IL); Matan Zehavi, Magal (IL)

(21) Appl. No.: 19/191,947

(22) Filed: Apr. 28, 2025

Related U.S. Application Data
(63) Continuation-in-part of application No. 18/648,642, filed on Apr. 29, 2024, now Pat. No. 12,328,007.
Application No. 18/648,642 is a continuation of application No. 18/297,832, filed on Apr. 10, 2023, now Pat. No. 12,034,309.
Application No. 18/297,832 is a continuation of application No. 17/493,894, filed on Oct. 5, 2021, now Pat. No. 11,652,351.
Application No. 17/493,894 is a continuation of application No. 16/844,212, filed on Apr. 9, 2020, now Pat. No. 11,165,241.
Application No. 16/844,212 is a continuation of application No. 15/669,114, filed on Aug. 4, 2017, now Pat. No. 10,658,833.
Application No. 15/669,114 is a continuation-in-part of application No. 15/078,450, filed on Mar. 23, 2016, now Pat. No. 11,062,588.
(63) Continuation-in-part of application No. 18/541,461, filed on Dec. 15, 2023.
Application No. 18/541,461 is a continuation of application No. 17/506,546, filed on Oct. 20, 2021, now Pat. No. 11,881,371.
(60) Provisional application No. 62/376,693, filed on Aug. 18, 2016.
(60) Provisional application No. 63/132,624, filed on Dec. 31, 2020.
(60) Provisional application No. 63/094,399, filed on Oct. 21, 2020.

(51) Int. Cl. H02J 3/46; G01K 11/06; G08B 17/06; H01H 33/02; H01H 85/04; H02H 1/00; H02H 3/33; H02J 3/38; H02J 7/35; H02S 40/34; H02S 40/36

(52) U.S. Cl. CPC H02J 3/46; G01K 11/06; H01H 33/02; H01H 85/04; H02H 1/0015; H02H 3/334; H02J 3/38; H02J 3/381; H02J 7/35; H02S 40/34; H02S 40/36; G08B 17/06; H02J 2300/26; Y02E 10/56

(57) ABSTRACT

Various implementations described herein are directed to a method for detecting, by a device, an increase in temperature at certain parts of an electrical system, and taking appropriate responsive action. The method may include measuring temperatures at certain locations within the system and estimating temperatures at other locations based on the measurements. Some embodiments disclosed herein include an integrated cable combining electrical conduction and heat-detection capabilities, or an integrated cable or connector combining electrical conduction with a thermal fuse.

### RELATED APPLICATIONS

The present application is a continuation-in-part of U.S. patent application Ser. No. 18/648,642, filed Apr. 29, 2024, which is a continuation of U.S. patent application Ser. No. 18/297,832, filed Apr. 10, 2023 (now U.S. Pat. No. 12,034,309), which is a continuation of U.S. patent application Ser. No. 17/493,894, filed Oct. 5, 2021 (now U.S. Pat. No. 11,652,351), which is a continuation of U.S. patent application Ser. No. 16/844,212, filed Apr. 9, 2020 (now U.S. Pat. No. 11,165,241), which is a continuation of U.S. patent application Ser. No. 15/669,114, filed Aug. 4, 2017 (now U.S. Pat. No. 10,658,833), which is a continuation-in-part application of U.S. patent application Ser. No. 15/078,450, filed Mar. 23, 2016 (now U.S. Pat. No. 11,062,588), and claims the benefit of U.S. provisional application Ser. No. 62/376,693, filed Aug. 18, 2016, which are hereby incorporated by reference in their entireties.

The present application is also a continuation-in-part of U.S. patent application Ser. No. 18/541,461, filed Dec. 15, 2023, which is a continuation of U.S. patent application Ser. No. 17/506,546, filed Oct. 20, 2021 (now U.S. Pat. No. 11,881,371), which claims the benefit of U.S. provisional application Ser. No. 63/094,399 filed Oct. 21, 2020 and U.S. provisional application Ser. No. 63/132,624 filed Dec. 31, 2020, which are hereby incorporated by reference in their entireties.

### BACKGROUND

Faulty connectors and/or conductors may cause overheating of components in electrical systems, and in some cases may even cause fires. Arc detection circuits might not always be triggered in cases of overheating. Overheating of conductors may be an especially acute problem in renewable power systems (e.g. photovoltaic and wind-power systems), where temperatures of system components may already be high due to exposure to the sun and the heating of components during power generation and conversion. Additionally, connectors may be prone to overheating due to the erosion of electrical contact mechanisms over time. Cost-effective detection of overheating of sections of power systems which are not adjacent to components containing logical circuitry (e.g. connectors or conductor areas which are not adjacent to system sensors and/or devices) may be an especially challenging task. There is a need for effective solutions for rapid detection of and response to overheating of components in such systems.

Additionally, a circuit breaker may be inserted into an electrical circuit to protect the electrical circuit from damage caused by an excess current from an overload or from a short circuit. A thermal fuse is a kind of circuit breaker that may be used in temperature sensitive devices in order to cut off (e.g., “break”) a circuit in which the thermal fuse is an element. Should the temperature in the thermal fuse overheat, due, for instance, to a fire, a short circuit, an arcing condition, or some other abnormal operation condition, the thermal fuse may cause the circuit to open. Thermal fuses may be single-use devices that include an element that deforms as a consequence of high temperature, rendering the thermal fuse unusable.

### SUMMARY

The following summary is a short summary of some of the inventive concepts for illustrative purposes only, and is not intended to limit or constrain the inventions and examples in the detailed description. One skilled in the art will recognize other novel combinations and features from the detailed description.

Embodiments herein may employ temperature sensing devices configured to detect overheating of components within a power system.

In illustrative electrical systems, a temperature sensor may be deployed a certain distance from a point considered susceptible to overheating, such as a connection point. Since heat may dissipate rapidly when traveling through a physical medium, the system may be designed for placement of sensors close enough to susceptible points to measure an increase in temperature which may trigger preventative actions such as disconnecting elements of the electrical system. In some systems, it might not be convenient or cost-effective to place temperature sensors close enough to sensitive points to detect overheating. In those systems, it may be desirable to combine thermocouple (TC) or linear heat detection (LHD) cables with the standard system conductors to allow detection of excessive heat at longer distances.

In many electrical systems, especially those exposed to weather conditions, connection points may be the most susceptible to intrusion of moisture and dirt, which may lead to increased electrical impedance and possible overheating. In some photovoltaic electrical systems, faulty connectors have overheated, leading to destructive fires. Therefore, many illustrative embodiments include detecting overheating at or near connection points (e.g. placement of a temperature sensor in or within 20 cm of a connection point), though this disclosure is not limiting in that respect and applies to overheating detection at other locations as well.

In some illustrative embodiments, designing for connector locations near temperature sensors may help detect high temperatures. For example, in certain systems such as some photovoltaic (PV) installations, a connection point may be formed by connecting two cables, with the connection point in proximity to a circuit (e.g. a direct current to alternating current (DC-AC) inverter such as a DC-AC micro-inverter, or a direct current to direct current (DC-DC) converter). In cases where the cables are of significant length, by designing cables of asymmetric length, proximity of each connection point to a power device may be achieved. For example, each power device may feature one cable 0.8 meters long, and one cable 0.2 meters long. In this case, if multiple power devices are coupled to one another, each connection point is only 0.2 meters away from a power device, and at that relatively short distance, a temperature sensor adjacent to the power device may detect overheating at the connection point.

In some embodiments, it may be desirable to detect overheating of electrical conductors at locations which might not be near connector locations. For example, in some photovoltaic installations, portions of electrical conductors may be in contact with metallic objects (e.g. outdoor metallic mounting structures which reach high temperatures), and/or may be adjacent to an inflammable agent (e.g. a wooden rooftop), and/or may be chewed on and damaged by animals, increasing the risk of overheating. Illustrative embodiments include integrated electrical cables combining electrical conductors with heat detection devices (e.g. thermocouple and LHD devices) which may detect overheating at locations not adjacent to thermal sensors deployed by connection locations.

Configuration of overheating detection systems and devices may vary according to system characteristics and requirements. For example, in some embodiments, a temperature threshold may be set to trigger a response to prevent melting of electrical conductor insulation. In some embodiments, a different temperature threshold may be set to trigger a response to prevent a wooden rooftop from catching fire or a tar roof coating from melting.

In some embodiments, a temperature threshold may be set at a temperature sensor to prevent overheating to a certain temperature at a location susceptible to overheating. The relationship between the temperature measured by a temperature sensor at a sensor location and the temperature at a location susceptible to overheating may be different depending on the distances between the two locations, the physical medium and the materials comprising the components of the electrical system.

Responses to a potentially unsafe overheating condition may vary. In some embodiments, a potentially unsafe overheating condition may trigger an automatic action, such as opening safety switches to disconnect the point of overheating from other circuitry. In some embodiments, a potentially unsafe overheating condition may trigger a disconnection of one or more thermal fuses disposed at electrical connection points. In some embodiments, a potentially unsafe overheating condition may trigger an overheating response such as operating a power device (e.g., a power converter) to reduce power drawn from a power source (e.g., a photovoltaic generator) and/or reducing voltage or current provided at the output of the power converter. In some embodiments, a potentially unsafe overheating condition may trigger an overheating response such as triggering an alarm system and/or updating a user interface monitored by a system owner and/or system maintenance personnel.

In some systems, analyses of previous instances of overheating may assist in predicting overheating events. For example, a system may feature certain patterns of voltage and current levels in different parts of the system prior to or at the early stages of overheating. Since many systems include data logging of operating parameters (e.g. voltage, current, frequency, harmonic content, solar irradiance etc.), in some instances it is possible to predict overheating based on measurements other than temperature, and take preventative action.

Systems, apparatuses, and methods are described for thermal fuse circuit breakers (hereinafter, “thermal fuses”, or, in the singular, “thermal fuse”). The thermal fuses described herein may be disposed in an electronic device, such as a connector, so that, following an overheating condition, for example, due to an arc discharge across or inside of the connector, the abnormally high temperature deforms a portion of the fuse, thereby limiting the damage from a potentially catastrophic event, such as fire, or damage to a component which may be more expensive than the thermal fuse itself.

As noted above, this summary is merely a summary of some of the features described herein. It is not exhaustive, and it is not to be a limitation on the claims.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures.

FIG. 1 is a flow diagram of a method for detecting overheating in an electrical conductor according to one or more illustrative aspects of the disclosure.

FIG. 2 is part-schematic, part block diagram of a system for detecting overheating in an electrical conductor according to one or more illustrative aspects of the disclosure.

FIG. 3 is part-schematic, part block diagram of a system for detecting overheating in an electrical conductor according to one or more illustrative aspects of the disclosure.

FIG. 4 is part-schematic, part block diagram of a system for detecting overheating in an electrical conductor according to one or more illustrative aspects of the disclosure.

FIG. 5 illustrates a portion of a photovoltaic string according to one or more illustrative aspects of the disclosure.

FIG. 6 illustrates a photovoltaic panel according to one or more illustrative aspects of the disclosure.

FIG. 7 illustrated a portion of a photovoltaic string according to one or more illustrative aspects of the disclosure.

FIG. 8A depicts an integrated heat-detecting electrical conductor according to one or more illustrative aspects of the disclosure.

FIG. 8B depicts integrated heat-detecting electrical connectors according to one or more illustrative aspects of the disclosure.

FIG. 9 is a flow diagram of a method for detecting overheating in an electrical conductor according to one or more illustrative aspects of the disclosure.

FIG. 10 is a flow diagram of a method for predicting a potentially unsafe condition according to one or more illustrative aspects of the disclosure.

FIG. 11 is a block diagram of an illustrative distributed system for carrying out some of the illustrative methods according to aspects of the disclosure.

FIG. 12 depicts an integrated heat-detecting electrical connector according to one or more illustrative aspects of the disclosure.

FIG. 13A depicts a portion of a photovoltaic string according to one or more illustrative aspects of the disclosure.

FIG. 13B depicts a portion of a photovoltaic string according to one or more illustrative aspects of the disclosure.

FIG. 13C depicts a portion of a photovoltaic string according to one or more illustrative aspects of the disclosure.

FIG. 14 depicts an integrated heat-detecting electrical connector according to one or more illustrative aspects of the disclosure.

FIG. 15 depicts a method for operating a power converter according to one or more illustrative aspects of the disclosure.

FIG. 16 shows an illustration of a first thermal fuse in a connector.

FIG. 17 shows a cross-section of a connector, such as a connector which might be used in a photovoltaic module for generation of electricity.

FIG. 18 shows various designs for a phase in a stamping process for manufacturing thermal fuses.

FIG. 19 shows an isometric view of a thermal fuse.

FIG. 20A shows a first cross section view of the thermal fuse of FIG. 19.

FIG. 20B shows a longitudinal cross section view of the thermal fuse of FIG. 20.

FIG. 20C shows a transversal cross section view of the thermal fuse of FIG. 20.

FIG. 21 shows the thermal fuse, e.g., of FIGS. 19 and 20A-20C, in a connector.

FIG. 22A shows the thermal fuse during an arcing event.

FIG. 22B shows the thermal fuse of FIG. 22A after the arcing event.

FIGS. 23A and 23B show a thermal fuse assembly.

FIGS. 24A-24C show a thermal fuse assembly.

FIG. 25A shows a thermal fuse assembly.

FIG. 25B shows a first spring based thermal fuse assembly in a closed state.

FIG. 25C shows the first spring based thermal fuse assembly in an open state.

FIG. 25D shows a second spring based thermal fuse assembly in a closed state.

FIG. 25E shows the second spring based thermal fuse assembly in an open state.

FIG. 25F shows a third spring based thermal fuse assembly in a closed state.

FIG. 25G shows the third spring based thermal fuse assembly in an open state.

FIG. 25H shows a fourth spring based thermal fuse assembly in a closed state.

FIG. 25I shows the fourth spring based thermal fuse assembly in an open state.

FIG. 25J shows a fifth spring based thermal fuse assembly in a closed state.

FIG. 25K shows the fifth spring based thermal fuse assembly in an open state.

FIG. 26 shows the thermal fuse in a connector, for example, in a photovoltaic energy system.

FIG. 27A shows the thermal fuse in a plug portion of the connector, for example, in a photovoltaic energy system.

FIG. 27B shows the thermal fuse in a socket portion of the connector, for example, in a photovoltaic energy system.

FIG. 27C shows a circuit disposed in the connector and acting as the thermal fuse.

FIG. 27D shows an example of an oscillator circuit which may be disposed in parallel to the thermal fuse.

FIG. 27E is a flowchart describing operation of the bypass alarm circuit of FIG. 27D.

FIG. 27F shows an example of an inductor circuit which may be disposed in parallel to the thermal fuse.

FIG. 27G shows another aspect which may be implemented in the thermal fuse described herein.

FIG. 28 shows several examples of use of a connector comprising a thermal fuse in a photovoltaic energy system.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made, without departing from the scope of the present disclosure.

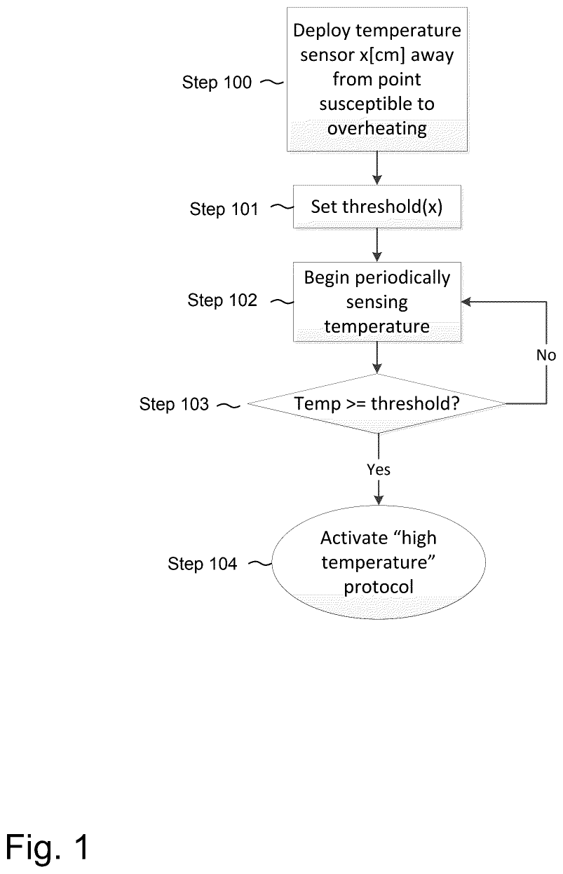

Reference is now made to FIG. 1, which shows a flow diagram of a method for detecting overheating in an electrical conductor according to one or more illustrative aspects of the disclosure. At step 100, a temperature sensor may be deployed at a distance of x[cm] from a point considered to be susceptible to overheating (e.g. a connection point, hereafter referred to as “CP”). By solving appropriate thermal differential equations, the temperature at the CP may be estimated as a function of the temperature measured by the sensor. In some embodiments, the relationship between the temperature at the CP and the temperature measured by the sensor may be empirically determined prior to deploying the sensor and connecting conductors at the connection point. For example, a sensor may be placed adjacent to a conductor in lab conditions, with a connection point x[cm] away. The connection point may be heated to a set of different temperatures, with the various CP temperatures and corresponding sensor measurements logged for future reference. In some embodiments, a lookup table may be created, the lookup table relating the temperature at the CP to the temperature measured by the sensor. The lookup table may be saved to memory on a device carrying out the method of FIG. 1 for reference during the course of the method, and/or may be used to configure the device before carrying out the method of FIG. 1. In some embodiments, CP temperatures and corresponding sensor measurements may be used to create a mathematical model relating an approximation of CP temperatures to the sensor measurements. The mathematical model may be a linear, higher-order polynomial, logarithmic, exponential or rational function. For example, in some embodiments where the physical structure between the temperature sensor and the CP comprises a single material and/or simple geometric shapes, a linear approximation may suffice to obtain a reasonably accurate approximation of the CP temperature. In some embodiments where the physical structure between the temperature sensor and the CP comprises multiple materials and/or sophisticated geometric shapes, a higher-order polynomial, a logarithmic or exponential function may provide a more accurate approximation of the CP temperature.

The temperature sensor deployed at step 100 may be coupled to a communication and/or processing device for receiving measurements from the sensor and transmitting and/or processing the measurements. For example, the sensor may output measurements onto an information bus, and the measurements may be read by a control device (e.g. a microprocessor, Digital Signal Processor (DSP), Field Programmable Gate Array (FPGA), Application Specific Integrated Circuit (ASIC) or other device), a communication device (e.g. a wireless transceiver, a power-line-communication (PLC) device and/or an acoustic communication device) and/or a memory device. A control device may be coupled to the sensor within a single device, or a control device may be remote and may process measurements transmitted by a communication device.

At step 101, a control device may be configured to respond to a temperature measurement above a threshold. The threshold may be determined in accordance with solving equations relating the temperature at the CP to the temperature measured at the sensor, or in accordance to a relationship determined to exist between the temperature at the CP and the temperature measured by the sensor and stored by a lookup table as disclosed above. In some embodiments, the threshold may be an absolute temperature. For example, a threshold may be set to 100° C., 200° C. or 300° C. A fixed threshold may be set with regard to the flammability of materials near the CP. For example, conductors used in photovoltaic installations may be insulated using cross-linked polyethylene (XLPE), polyvinyl chloride (PVC) or chlorinated polyvinyl chloride (CPVC). XLPE-insulated conductors may have a rated maximum conductor temperature of 90° C., an emergency rating of up to 140° C. and a short-circuit rating of 250° C. If protecting the insulation is desired, a threshold may be set with regard to the emergency rating. Cables having PVC or CPVC insulation or other types of insulation may feature different ratings, and different thresholds may be set accordingly.

In some embodiments, a threshold may be set with regard to the flammability of structures supporting the electrical system. For example, many photovoltaic electrical systems are mounted on buildings having wooden roofs. The temperature at which wood begins to burn depends on the type of wood, but typically, the pyrolysis of wood begins at temperatures around 250° C. Some roofs may be coated with tar, which may begin to auto-ignite at about 315° C. In some embodiments, a system may be configured to not protect the conductor insulation from melting, but a response to protect the supporting roof from catching fire may be desirable.

In some embodiments, the threshold may be adaptive and may be set with relation to a previously measured temperature or previously measured system parameter values (e.g. voltage, current, solar irradiance). For example, a threshold may be set as THRESH[° C.]=baseline[° C.] +delta[° C.], where baseline[° C.] may be a temperature measured over period of time, and delta may be an increase in temperature over a period of time. For example, if a sensor measures a steady temperature 100±5[° C.] for one hour, delta may be set to equal 50[° C.] and the threshold may be 100[° C.]+50[° C.]=150[° C.]. If the steady temperature decreases to 90±5[° C.] for one hour, delta may still be set to equal 50[° C.] and the new threshold may be 90[° C.]+50[° C.]=140[° C.]. In some embodiments, delta may depend on baseline. For example, delta may equal 50[° C.] if baseline=100[° C.], while delta may equal 45[° C.] if baseline=90[° C.]. In some embodiments, the threshold may be set with regard to a probabilistic function. For example, the method may be interested in the temperature at a connection point, and the threshold may be set such that the temperature at the connection point remains below a certain temperature with high probability. For example, empirically-obtained data and/or mathematical models may indicate that when a sensor measures 100[° C.], the temperature at a connection point 20 cm away is above 90[° C.] with probability 50%, and when the sensor measures 110[° C.], the temperature at a connection point 20 cm away is above 90[° C.] with probability 80%. The threshold may be selected to trigger a response with regard to the acceptable temperature at the connection point and the probability of the acceptable temperature being surpassed.

In some embodiments, different thresholds may be set depending on other external variables. For example, temperature measurements may be considered in conjunction with other sensor measurements, such as voltage, current, solar irradiance, moisture or other measurements. For example, in a system a first threshold may be set to trigger a response if a temperature of 200° C. is measured 10 [cm] from an electrical connection and a current of 10 [A] is measured to be flowing through the connection, with a second threshold set to trigger a response if a temperature of 180° C. is measured 10 [cm] from an electrical connection and a current of 12 [A] is measured to be flowing through the connection.

In some embodiments, a system may be configured to respond to a temperature remaining above one or more thresholds for a period of time. For example, a system may be configured to respond to a first threshold temperature of 200° C. persisting for 10 seconds, and to respond to a second threshold temperature of 160° C. persisting for 12 seconds.

In some embodiments, a threshold may be set with regard to an increase in temperature. For example, a system may be configured to respond to an increase of 10° C. or more in 20 seconds or less, regardless of the absolute temperatures measured. In some embodiments, a system may be configured to respond to a variable increase of temperature which varies depending on the absolute temperature measured, as described above.

The thresholds described herein are only illustrative examples which may be used in different systems. Various combinations thereof may be applied to various electrical systems depending on system characteristics and requirements. At step 102, the temperature sensor may begin to periodically measure temperatures for transmission to control and/or memory devices. At step 103, a control device may compare a measured temperature to the threshold obtained at step 101. If the temperature is below the threshold, the operating conditions may be assumed to be safe and normal system operation may continue, with the method returning to step 102. In some embodiments, the method may periodically return to step 101, to recalculate the threshold based on current temperature measurements. If, at step 103, a temperature equal to or greater than the threshold is measured, the method may proceed to step 103, where an overheating response such as a “high temperature protocol” (HTP) is activated. In some embodiments, the HTP may comprise a controller automatically disconnecting the connection point from electrical current. In some embodiments, the HTP may comprise a controller reducing the electrical current flowing through the connection point, for example, by reducing power drawn from a power source connected at the input to the power device. In some embodiments, the controller may be coupled via a communication device to a wired and/or wireless network(s)/Internet/Intranet, and/or any number of end user device(s) such as a computer, smart phone, tablet and/or other devices such as servers which may be located at a network operations center and/or monitoring center. These devices may be utilized to generate a warning of a dangerous condition, determine when a dangerous condition is probable, detect the type of dangerous condition and/or take action to degrade or turn off certain portions a system. These warnings can be audio and/or visual. They may, for example, be a beep, tone, siren, LED, and/or high lumen LED.

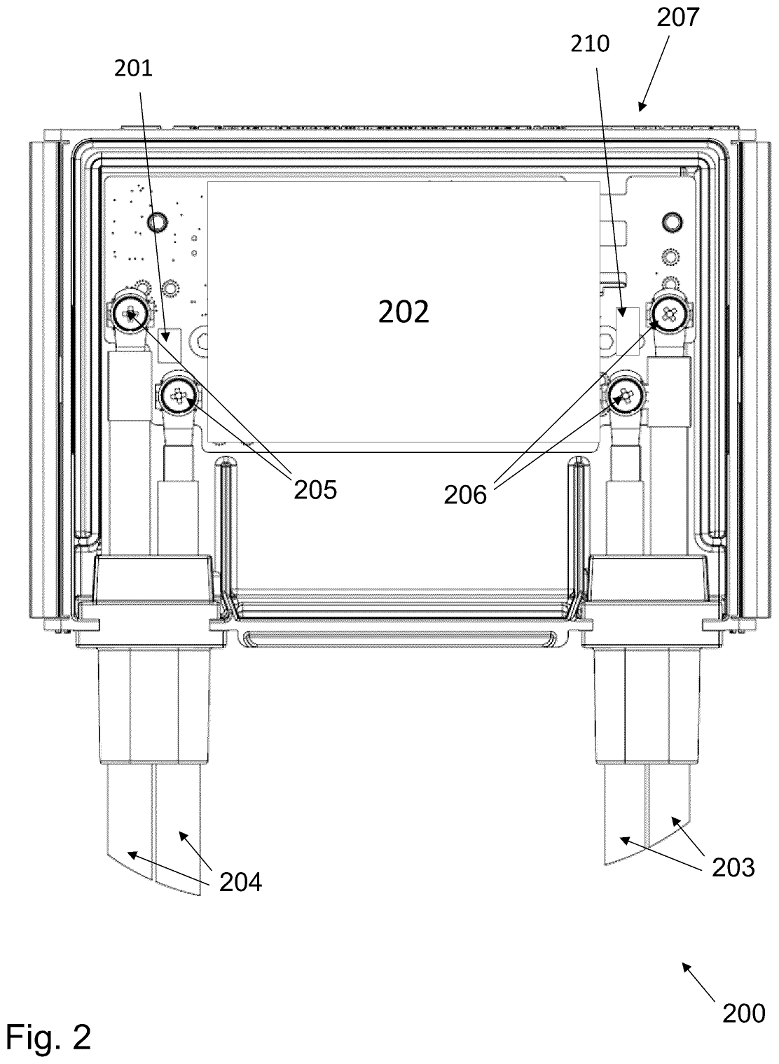

Reference is now made to FIG. 2, which shows part of a system for detecting overheating in an electrical conductor according to one or more illustrative aspects of the disclosure. Power device 200 may be configured to receive input electrical power from a power source (e.g. PV generator, wind turbine, hydro-turbine, battery, supercapacitor, fuel cell, etc.) and output electrical power to a load, such as an electrical device, a grid, a home, or a battery. PV generators may include one or more solar panels, solar cells, solar shingles, and/or strings (e.g. serial strings or parallel strings) of solar panels or solar cells. Power device 200 may comprise input conductors 203 for receiving electrical power, and output conductors 204 for outputting electrical power. Power device 200 may comprise circuitry 202 for power processing, control, monitoring, safety, and communication. Various elements comprising circuitry 202 will be described in greater detail later on in this disclosure. Circuitry 202 may receive power from input conductors 203, and output power via output conductors 204.

Still referring to FIG. 2, enclosure 207 may physically house the electrical components comprising a photovoltaic module, for example, power device 200. Enclosure 207 may be a closed or partially closed compartment. In some embodiments, enclosure 207 may comprise a portion of a junction box for a photovoltaic module (e.g. a PV generator), or may comprise a lid configured to fit to a junction box for a photovoltaic module. Input conductors 203 may be physically connected to enclosure 207 using an appropriate connecting method, such as, in this illustrative embodiment, screws 206. In some embodiments, input conductors may be secured to the enclosure by soldering, clamping or other methods. An electrical connection between input conductors 203 and circuitry 202 may be provided by a conducting path deployed between screws 206 and circuitry 202. Similarly, output conductors 204 may be physically connected to enclosure 207 using an appropriate connecting method, such as, in this illustrative embodiment, screws 205. In some embodiments, output conductors may be secured to the enclosure by soldering, clamping or other methods. An electrical connection between output conductors 204 and circuitry 202 may be provided by a conducting path deployed between screws 205 and circuitry 202.

Still referring to FIG. 2, temperature sensor 201 may be deployed adjacently to screws 205, and may be configured to transfer temperature measurements to controller or communication device (e.g. a controller or communication device included in circuitry 202). In case of overheating of one of output conductors 204, the temperatures measured by temperature sensor 201 may increase. Similarly, temperature sensor 210 may be similar to or the same as temperature sensor 201 may be deployed near screws 206 and may measure increases in temperature on or near input conductors 203. Temperature sensors 201 and/or 210 may be thermocouple devices, IC temperature sensors, silicon bandgap temperature sensors, thermistors, or any other suitable temperature sensor.

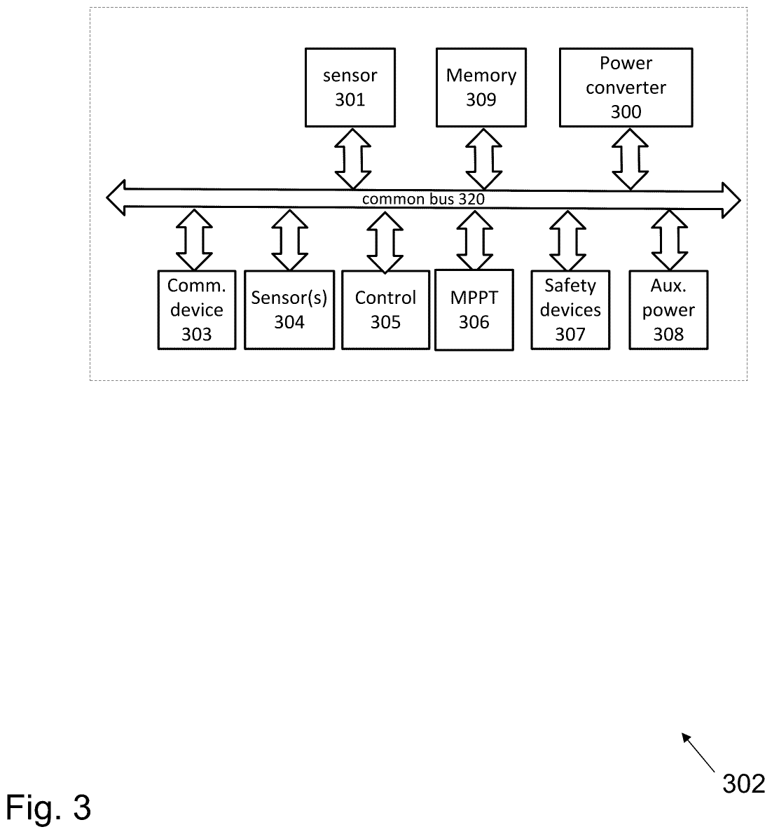

Reference is now made to FIG. 3, which illustrates circuitry 302 such as circuitry which may be found in a power device such as power device 200, according to an illustrative embodiment. Circuitry 302 may be similar to or the same as circuitry 202 illustrated in FIG. 2. In some embodiments, circuitry 302 may include power converter 300. Power converter 300 may comprise a direct current-direct current (DC/DC) converter such as a buck, boost, buck/boost, buck+boost, Cuk, Flyback and/or forward converter. In some embodiments, power converter 300 may comprise a direct current-alternating current (DC/AC) converter (also known as an inverter), such a micro-inverter. In some embodiments, circuitry 302 may include Maximum Power Point Tracking (MPPT) circuit 306, configured to extract increased power from a power source the power device is coupled to. In some embodiments, power converter 300 may include MPPT functionality. MPPT functionality may include, for example, a “perturb and observe” method and/or impedance matching. Circuitry 302 may further comprise control device 305 such as an analog control device, a microprocessor, Digital Signal Processor (DSP), Application-Specific Integrated Circuit (ASIC) and/or a Field Programmable Gate Array (FPGA).

Still referring to FIG. 3, control device 305 may control and/or communicate with other elements of circuitry 302 over common bus 320. In some embodiments, circuitry 302 may include circuitry and/or sensors/sensor interfaces 304 configured to measure parameters directly or receive measured parameters from connected sensors and/or sensor interfaces 304 configured to measure parameters on or near the power source, such as the voltage and/or current output by the power source and/or the power output by the power source. In some embodiments, the power source may be a PV generator, and a sensor or sensor interface may directly measure or receive measurements of the irradiance received by the generator and/or the temperature on or near the generator. In some embodiments, sensor 301 may be part of sensors/sensor interfaces 304, and in some embodiments sensor 301 may be a separate sensor. Sensor 301 may be similar to or the same as temperature sensor 201 of FIG. 2. For example, sensor 301 may be a temperature sensor deployed near a connection to a conductor, to monitor the temperature on or near the conductor to detect potential overheating.

Still referring to FIG. 3, in some embodiments, circuitry 302 may include communication device 303, configured to transmit and/or receive data and/or commands from other devices. Communication device 303 may communicate using Power Line Communication (PLC) technology, acoustic communication technology, or wireless technologies such as ZIGBEE™, Wi-Fi, BLUETOOTH™, cellular communication or other wireless methods. In some embodiments, circuitry 302 may include memory device 309, for logging measurements taken by sensor(s)/sensor interfaces 304 and/or sensor 301, to store code, operational protocols or other operating information. Memory device 309 may be flash, Electrically Erasable Programmable Read-Only Memory (EEPROM), Random Access Memory (RAM), Solid State Devices (SSD) or other types of appropriate memory devices.

Still referring to FIG. 3, in some embodiments, circuitry 302 may include safety devices 307 (e.g. fuses, circuit breakers and Residual Current Detectors). Safety devices 307 may be passive or active. For example, safety devices 307 may comprise one or more passive fuses disposed within circuitry 302 and designed to melt when a certain current flows through it, disconnecting part of circuitry 302 to avoid damage. In some embodiments, safety devices 307 may comprise active disconnect switches, configured to receive commands from a controller (e.g. control device 305, or an external controller) to disconnect portions of circuitry 302, or configured to disconnect portions of circuitry 302 in response to a measurement measured by a sensor (e.g. a measurement measured by sensor 301 or sensors/sensor interfaces 304). In some embodiments, circuitry 302 may comprise auxiliary power unit 308, configured to receive power from a power source coupled to circuitry 302, and output power suitable for operating other circuitry components (e.g. control device 305, communication device 303, etc.). Communication, electrical coupling and/or data-sharing between the various components of circuitry 302 may be carried out over common bus 320.

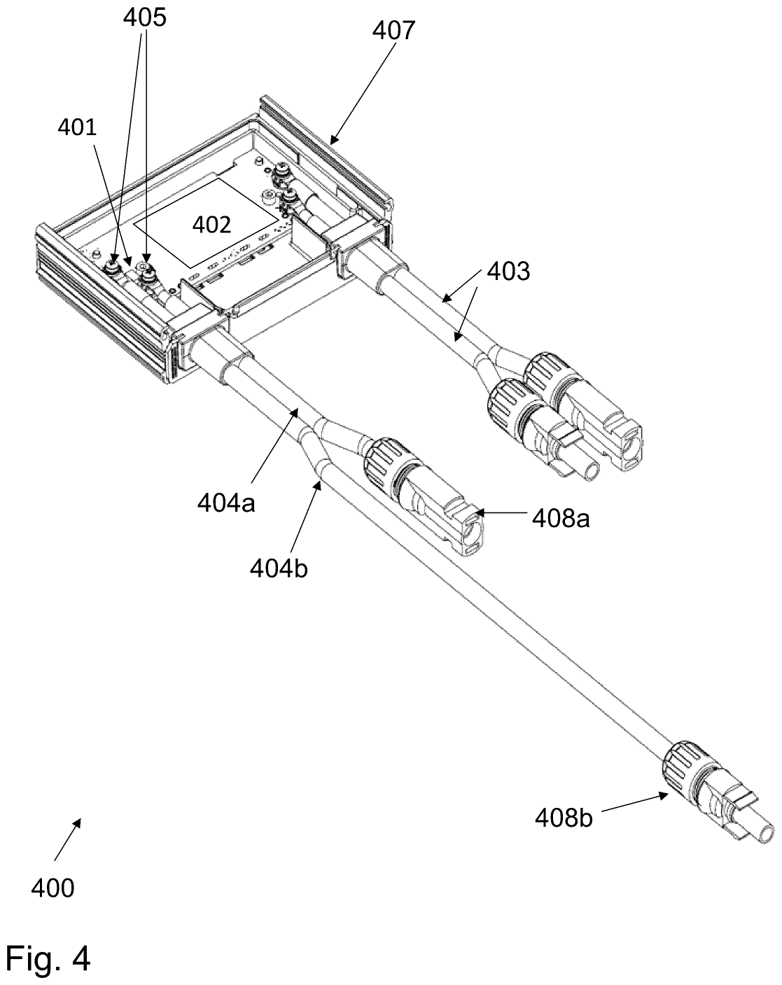

Reference is now made to FIG. 4, which illustrates aspects of illustrative embodiments. Power device 400 may comprise casing 407, circuitry 402, input conductors 403, output conductors 404a and 404b and fastening screws 405 which may be similar to or the same as similar components illustrated with regard to other embodiments disclosed herein. For example, circuitry 402 may include some or all of the components of circuitry 202 illustrated in FIG. 2. Temperature sensor 401 may be similar to or the same as sensors 201 and 210 of FIG. 2. In the illustrative embodiment depicted in FIG. 4, no sensor is deployed adjacently to input conductors 403, but alternative embodiments may include a sensor disposed adjacently to input conductors 403 and/or additional sensors. Connectors 408a and 408b may be connected at the ends of output conductors 404a and 404b, respectively, and may be configured to connect to connectors on other conductors fitted to be connectable to them. For example, connector 408b may be a male connector, and connector 408a may be a female connector. Connector 408b may be designed to be connected to female connectors similar to connector 408a, and connector 408a may be designed to be connected to male connectors similar to connector 408b.

In some electrical systems employing connectors similar to connectors 408a and 408b, faulty connectors may lead to a faulty electrical connection, which may cause arcing and/or overheating of the connectors. Excess heat may spread for the connectors to the conductors they are coupled to. In some systems, failure to detect gradual overheating of connectors and/or conductors may cause conductor insulation to catch fire, and significant damage and/or dangerous situations may ensue.

Output conductors 404a and 404b may be of appropriate length for connecting a plurality of power devices such as 400 when deployed in an electrical installation. For example, power device 400 may be designed to be a photovoltaic (PV) module or to be coupled to a different PV module (e.g. a PV generator), and a plurality of power devices similar to or the same as power device 400 may be coupled in series or in parallel to form a photovoltaic string carrying the power from a plurality of PV modules. In some embodiments, coupled power devices such as 400 may be deployed a certain distance apart from each other. For example, in some embodiments, adjacent power devices may be deployed 1 meter or 2 meters apart from one another. In some embodiments, each power device may comprise output conductors of about equal length, where the sum of the lengths of the conductors is about the same as the distance between the power devices. For example, if two power devices (e.g. devices such as power device 400) are deployed about 1 meter apart, each device may comprise two output cables of about 0.5 meters each, so that the male connector of one device's output conductors may be coupled to the female connector of the other device's output conductors.

In some photovoltaic systems, detecting an increasing temperature at connection points may be difficult due to significant distances between system temperature sensors and connection point locations. For example, common PV power devices include cables between around 50 [cm] and around 100 [cm] long. When two PV power devices are coupled, the connector location may be between 50 [cm] and 100 [cm] from a temperature sensor deployed in the PV power device, which might be too great a distance for effective detection of overheating at the connector location. In some embodiments, enhanced overheating detection may be obtained by designed connector locations to be close to a temperature sensor in the PV power device.

In the illustrative embodiment of FIG. 4, output conductor 404a is illustratively significantly shorter than output conductor 404b. As a numerical example, output conductor 404a may be 0.2 meters long, and output conductor 404b may be 0.8 meters long. When power devices featuring asymmetrically sized output conductors are coupled to each other, the connection point between the conductors may be closer to one device than the other. As a numerical example, if output conductor 404a is 0.2 meters long, and output conductor 404b is 0.8 meters long, when two power devices (e.g. devices such as power device 400) are coupled to one another, the connection location will be about 0.8 meters from one power device and 0.2 meters from the other power device. If one output conductor is very short and the other is very long, the connection location may be close enough to circuitry (e.g. temperature sensor 401) for the circuitry to detect an increase in heat at the connection point. In some embodiments, a thermocouple or LHD device may be deployed alongside an electrical conductor and integrated in input or output conductors (e.g. conductors 403, 404a and/or 404b) and coupled to a controller and/or communication device deployed in circuitry 402 to detect overheating at any point along the conductor.

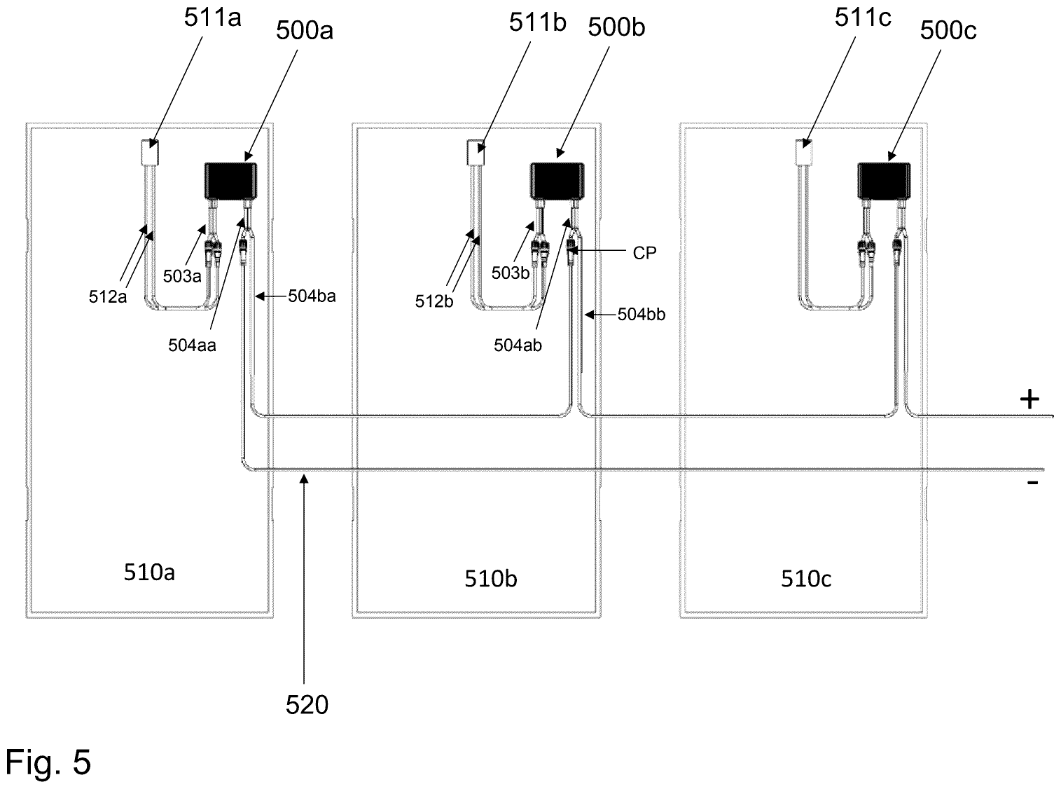

Reference is now made to FIG. 5, which illustrates a portion of a photovoltaic generation system according to aspects of illustrative embodiments. PV panels 510a, 510b and 510c may be part of a serial PV string. A PV panel may comprise a junction box (e.g. PV panel 510a comprises junction box 511a) designed to receive electrical power from PV cells (not explicitly illustrated, as PV cells are generally deployed on the opposite side of the panel as the junction box). Conductors may carry power output from the junction box. In some embodiments, power devices may be coupled to photovoltaic panels for monitoring and/or controlling the power output by the panels or for other operational or safety purposes. For example, power devices 500a and 500b may be coupled to PV panels 510a and 510b, respectively. Power devices (e.g. power devices 500a, 500b and 500c) may be coupled in series, to form a serial PV string. Conductor 520 may be coupled to the low-voltage output conductor terminal of power device coupled to the first panel in the string (in this illustrative embodiment, power device 500a coupled to PV panel 510a), and may form the lower-voltage string line. A higher-voltage string line may be formed by serially connecting the rest of the output conductors of the power devices comprising the string. The lower-voltage and higher-voltage string lines may be designed to be input to an appropriate device, for example, a direct-current (DC) combiner box, battery charging circuit or PV inverter designed to convert DC power produced by the PV panels to alternating-current (AC) power for consumption by a load (e.g. a home, grid or battery).

In the illustrative embodiment shown in FIG. 5, power device 500a is coupled to PV panel 510a. Power device 500a receives power from panel conductors 512a via input conductors 503a. Power device 500a outputs power via output conductors 504aa and 504ba. Similarly, power device 500b is coupled to PV panel 510b. Power device 500b receives power from panel conductors 512b via input conductors 503b. Power device 500a outputs power via output conductors 504ab and 504bb. Output conductors 504ba and 504ab are connected at connection point CP, which may be adjacent to power device 500b. If the connection between output conductors 504ba and 504ab at is faulty, the temperature at connection point CP may increase, and may be detected by a temperature sensor comprised by power device 500b (e.g. a sensor similar to or the same as sensors 201, 210 or 410 as described herein). Multiple power device may be coupled to one another in a similar manner, enabling connecting points to be adjacent to power devices configured to detect increases in temperature.

In some embodiments, some or all of the power device input and/or output conductors may include thermal devices designed to respond to or measure rising temperatures. For example, in some embodiments, some or all of the system conductors may include thermocouple wires deployed alongside conductors designed to carry the electrical power. In some embodiments, each system conductor may include a thermocouple wire connected to a sensor in a power device (e.g. power device 500a), enabling the power device to sense a rise in temperature at any point along the conductor. In some embodiments, costs may be reduced by deploying thermocouple wires only in short conductors (e.g. input conductors 503a, 503b and output conductors 504aa, 504ab). In some embodiments, each system conductor may include a Linear Heat Detector (LHD) coupled to a controller in a power device (e.g. power device 500a). In some embodiments, a rise in temperature at any point along the conductor may cause the LHD wires to come into contact with one another, triggering an electrical pulse that may be detected by a controller configured to take action in response to receiving a pulse. In some embodiments, costs may be reduced by deploying LHD wires only in short conductors (e.g. input conductors 503a, 503b and output conductors 504aa, 504ab).

FIG. 5 illustrates a system comprising add-on power devices coupled to PV panels. In some embodiments, some or all of the power device functionalities may be embedded into a PV panel junction box.

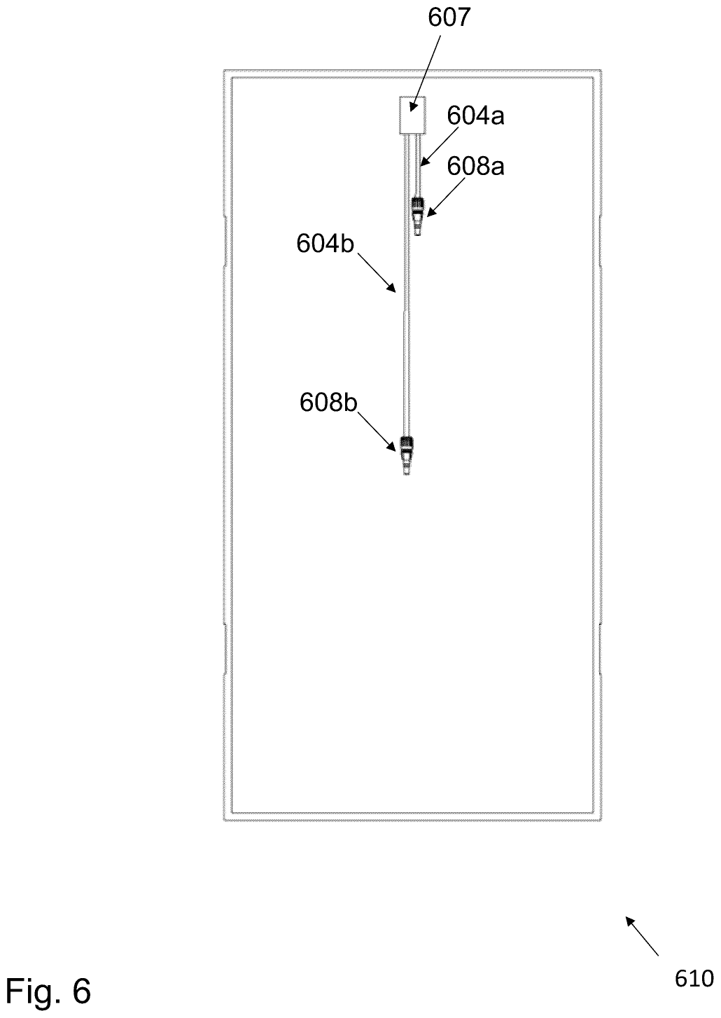

Reference is now made to FIG. 6, which illustrates an integrated photovoltaic panel according to illustrative embodiments. PV panel 610 comprises PV cells (not explicitly depicted) and junction box 607, configured to receive power from the PV cells. Junction box 607 may feature an integrated power device comprise some or all of the functional elements described herein with regard to illustrative power devices (e.g. some or all of the elements of circuitry 302 described with regard to FIG. 3). For example, junction box 607 may comprise a temperature sensor similar to or the same as sensors 201 and 210, a controller similar to or the same as control device 305, and a safety device such as switches (e.g. Metal Oxide Silicon Field Effect Transistors (MOSFETs), Insulated-Gate Bipolar Transistors (IGBTs), Bipolar Junction Transistors (BJTs), electro-mechanical or solid-state relays, etc.) configured to disconnect output conductors 604a and 604b. In some embodiments, junction box 607 may include a power converter, communication device and MPPT circuit which are similar to or the same as power converter 300, communication device 303 and MPPT circuit 306, respectively. Output conductors 604a and 604b may be designed to carry the electrical power output from junction box 607, and may be fastened to connectors 608a and 608b, respectively. Many common photovoltaic panels feature output conductors which are about the same length, and may be of an appropriate length for adjacent PV panels to be connected to each other. In some embodiments of the current disclosure, such as in the embodiment shown in FIG. 6, one conductor may be longer than the other. For example, output conductor 604b may be significantly longer than output conductor 604a. As a numerical example, output conductor 604b may be about 1.8 meters long, and output conductor 604a may be about 0.2 meters long.

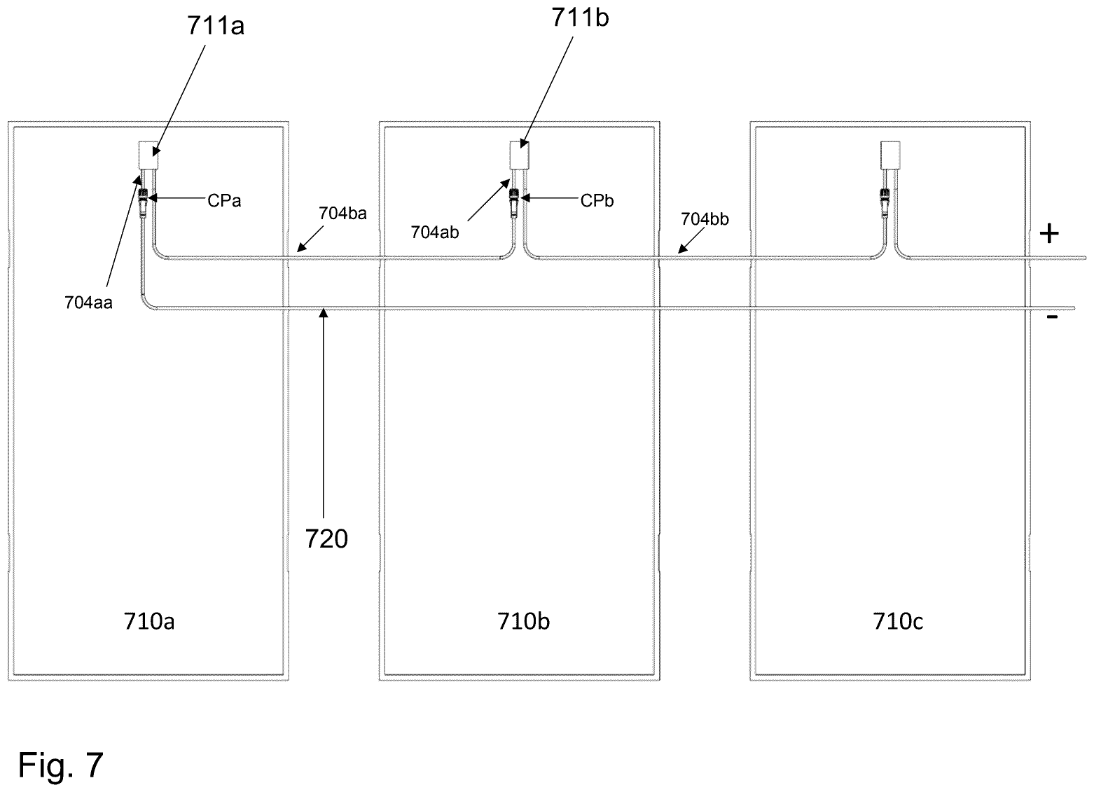

Connecting PV panels using asymmetrical conductors may, in some embodiments, increase the likelihood of detecting a rise in temperature due to a faulty connection. Reference is now made to FIG. 7, which shows a portion of a PV string according to illustrative embodiments. PV panels 710a, 710b and 710c may be serially connected to form part of a PV string. A PV panel may comprise a junction box (e.g. PV panel 710a comprises junction box 711a) designed to receive electrical power from PV cells (not explicitly illustrated, as PV cells are generally deployed on the opposite side of the panel as the junction box). Conductors may carry power output from the junction box. Conductor 720 may be coupled to the low-voltage output conductor of the first panel in the string (in this illustrative embodiment, PV panel 710a), and may form the lower-voltage string line. A higher-voltage string line may be formed by serially connecting the rest of the output conductors of the PV panels comprising the string. The lower-voltage and higher-voltage string lines may be designed to be input to an appropriate device a direct-current (DC) combiner box, MPPT circuit, battery charging circuit or PV inverter designed to convert DC power produced by the PV panels to alternating-current (AC) power for consumption by a load (e.g. a home, grid or battery).

In the illustrative embodiment shown in FIG. 7, PV panel 710a is coupled to PV panel 710b. Conductor 720 may be coupled to the lower-voltage conductor 704aa of panel 710a at connection point CPa. PV panel 710a may be coupled to PV panel 710b by connecting output conductor 704ba of panel 710a to output conductor 704ab of panel 710b at connection point CPb. If the connection between output conductors 704ba and 704ab at is faulty, the temperature at connection point CPb may increase, and may be detected by a temperature sensor disposed in junction box 711b (e.g. a sensor similar to or the same as sensors 201, 210 or 410 as described herein). Multiple PV panels may be coupled to one another in a similar manner, enabling connecting points to be adjacent to PV panels configured to detect increases in temperature.

In some embodiments, some or all of the PV panel output conductors may include thermal devices designed to respond to or measure rising temperatures. For example, in some embodiments, some or all of the output conductors may include thermocouple wires deployed alongside conductors designed to carry the electrical power. In some embodiments, each system conductor may include a thermocouple wire connected to a sensor in a junction box (e.g. junction box 711a), enabling the sensor to sense a rise in temperature at any point along the conductor. In some embodiments, costs may be reduced by deploying thermocouple wires only in short conductors (e.g. output conductors 704aa, 704ab). In some embodiments, each system conductor may include a Linear Heat Detection (LHD) coupled to a controller in a junction box (e.g. junction box 711a). In some embodiments, a rise in temperature at any point along the conductor may cause the LHD wires to come into contact with one another, triggering an electrical pulse that may be detected by a controller configured to take action in response to receiving a pulse. In some embodiments, costs may be reduced by deploying LHD wires only in short conductors (e.g. output conductors 704aa, 704ab).

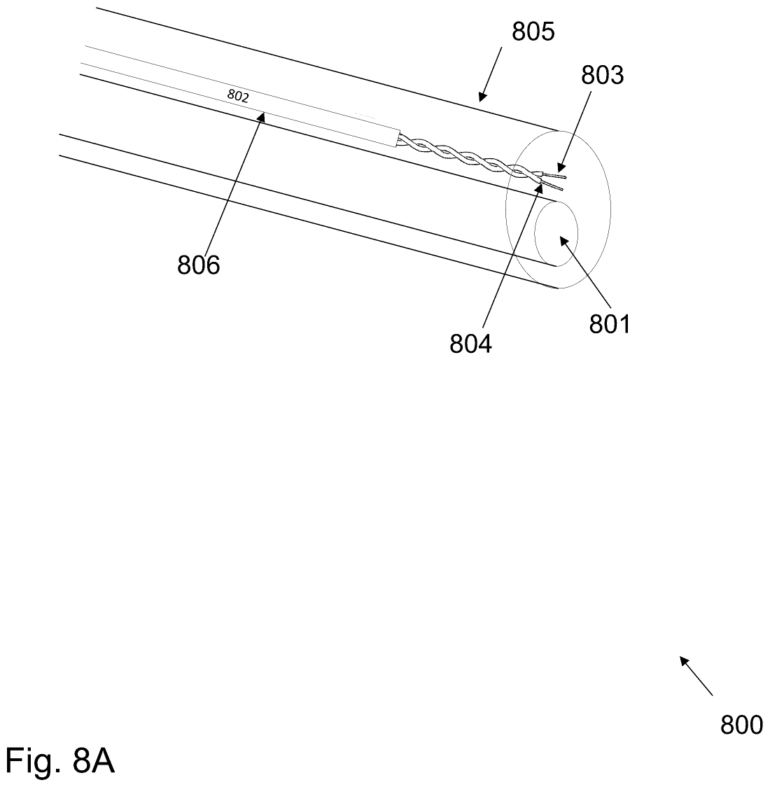

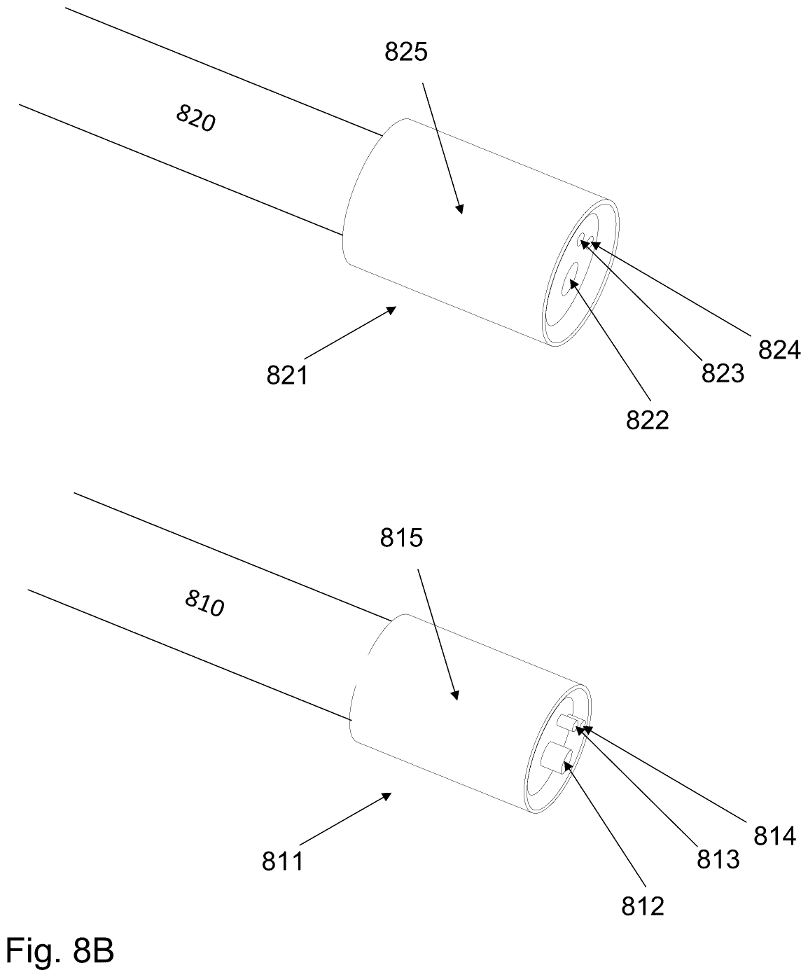

Reference is now made to FIG. 8A, which illustrates an integrated electrical cable according to illustrative embodiments. Integrated cable 800 may comprise conductor(s) 801 and heat detector 802. Conductor(s) 801 may be made of copper, aluminum or other appropriate conducting materials. In the illustrative embodiment of FIG. 8A, conductor(s) 801 is illustrated having a single conductor. In some embodiments, conductor(s) 801 may comprise several separate conductors (e.g. 2, 3, 4, 5, 10, 20 or even 40 conductors), each made of an appropriate conducting material. Heat detector 802 may comprise wires 803 and 804. In some embodiments, wires 803 and 804 may be wound together to form a thermocouple pair configured to measure temperature at a contact point. For example, the ends of wires 803 and 804 may be coupled at a connection point in a PV string, with a temperature sensor located in a power device (e.g. temperature sensor 401 of power device 400) or a PV junction box (e.g. junction box 711a) measuring the temperature at the contact point via the thermocouple pair. If a temperature above a certain threshold is measured, a controller and/or communication device coupled to the sensor may take action (e.g. reporting a potentially dangerous situation or disconnecting a circuit) in accordance with embodiments disclosed herein.

Still referring to FIG. 8A, in some embodiments, heat detector 802 may be a Linear Heat Detector (LHD). Wires 803 and 804 may be insulated, with the insulation designed to melt at a certain temperature, creating an electrical contact between wires 803 and 804. For example, the insulation between wires 803 and 804 may be designed to melt at a threshold temperature set with regard to criteria described herein. Common LHD devices feature insulation designed to melt at about 90° C., 105° C., 135° C. and 180° C. In case of overheating at any point in integrated cable 800, a local temperature may rise above the threshold temperature, bringing wires 803 and 804 into electrical contact which may create a short-circuit. Wires 803 and 804 may be coupled to a power device (e.g. temperature sensor 401 of power device 400) or a PV junction box (e.g. junction box 711a) comprising circuitry designed to detect a short-circuit, and upon detection, a controller and/or communication device coupled may take action (e.g. reporting a potentially dangerous situation or disconnecting a circuit) in accordance with embodiments disclosed herein.

In some illustrative embodiments, wires 803 and 804 may be enclosed in insulation 806, creating additional separation and isolation from conductor(s) 801. In some embodiments, additional insulation might not be necessary. Integrated cable 800 may include casing 805, which encloses conductor(s) 801 and heat detector 802 for fast and easy deployment.

In some embodiments, heat detector 802 may comprise a thermistor or resistance thermometer coupled in series to a single wire, with the wire resistance measured periodically to detect a change in resistance which may be indicative of overheating. The wire resistance may be measured in various ways, such as applying a voltage between the wire ends and measuring current.

Integrated cables similar to or the same as integrated cable 800 may be used in various systems. In some embodiments, PV panels or other power sources may comprise one or more integrated cable(s) providing electrical connection along with heat-detecting capabilities. For example, a PV panel (e.g. PV panel 610) may include an output conductor (e.g. output conductor 604b) which may be a “regular” conductor, and one output conductor (e.g. output conductor 604a) comprising an integrated cable such as or similar to integrated cable 800. In some embodiments, PV power-devices (e.g. power device 400) may comprise one or more integrated cables. For example, a PV power device (e.g. power device 400) may feature one output conductor (e.g. output conductor 404b) which may be a “regular” conductor, and one output conductor (e.g. output conductor 404a) comprising an integrated cable similar to or the same as integrated cable 800. In some embodiments, a PV power device may have one or more input conductors (e.g. input conductors 403) comprise an integrated cable. In some embodiments, integrated cables may be deployed in homes, factories, shopping malls or in any other electrical system where heat-detecting capabilities may enhance electrical safety. Integrated cables may be deployed in particularly sensitive parts of electrical systems, or more broadly across entire systems.

Reference is now made to FIG. 8B, which illustrates integrated heat-detecting electrical connectors according to one or more illustrative aspects of the disclosure. Integrated connector 811 may comprise outer section 815, conductor pin 812 and temperature-device pins 813 and 814. In some embodiments, integrated cable 810 may be coupled to integrated connector 811. Integrated cable 810 may be similar to or the same as integrated cable 800 of FIG. 8A, with a conductor similar to or the same as conductor(s) 801 coupled to conductor pin 812, and wires similar to or the same as wires 803 and 804 coupled to temperature-device pins 813 and 814. In some embodiments, a connector similar to or the same as integrated connector 811 may be part of an electrical device, such as a PV power device (e.g. a DC/DC converter or a DC/AC inverter), with conductor pin 812 carrying input current into or out of the electrical device, and temperature-device pins 813 and 814 coupled to an appropriate control device.

Still referring to FIG. 8B, integrated connector 821 may comprise outer section 825, conductor cavity 822 and temperature-device cavities 823 and 824. In some embodiments, integrated cable 820 may be coupled to integrated connector 821. Integrated cable 820 may be similar to or the same as integrated cable 800 of FIG. 8A, with a conductor similar to or the same as conductor(s) 801 coupled to conductor cavity 822, and wires similar to or the same as wires 803 and 804 coupled to temperature-device cavities 823 and 824. In some embodiments, a connector similar to or the same as integrated connector 821 may be part of an electrical device, such as a PV power device (e.g. a DC/DC converter or a DC/AC inverter), with conductor cavity 822 carrying input current into or out of the electrical device, and temperature-device cavities 823 and 824 coupled to an appropriate control device.

Integrated connectors 811 and 821 may be designed to fit together for connecting to each other. Conductor pin 812 may be designed to fit into conductor cavity 822, and temperature-device pins 813 and 814 may be designed to fit into temperature-device cavities 823 and 824. When integrated connectors similar to or the same as integrated connectors 811 and 821 are connected to one another, their respective conducting and temperature detecting elements may be coupled to one another, for serial stringing of the conducting and temperature detecting elements.

Referring back to FIG. 7, in some embodiments, connection points CPa and CPb may comprise integrated connectors similar to or the same as integrated connectors 811 and 821. Conductor 720 and/or conductors 704aa, 704ba, 704ab, and 704bb may be similar to or the same as integrated cable 800. In some embodiments, a (not explicitly depicted in FIG. 7) system control device may be part of an electrical device (e.g. a DC/DC converter, a DC/AC inverter, and/or a photovoltaic combiner box used to couple multiple photovoltaic strings in parallel) coupled between the higher-voltage and lower-voltage power lines. Connecting the integrated cables (e.g. conductors 720, 704aa, 704ba, 704ab, and 704bb) using integrated connectors may couple thermal devices (e.g. thermocouple, LHD) may enable the system control device to detect overheating at any point in the portion of a PV string depicted in FIG. 7 without requiring deployment of a controller in multiple locations.

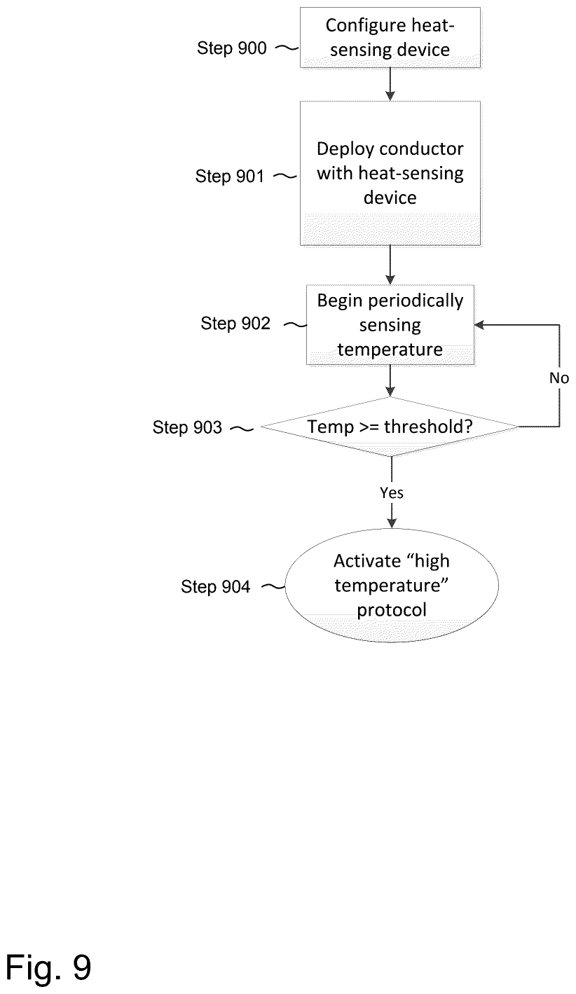

Reference is now made to FIG. 9, which shows a flow diagram of a method for detecting overheating in an electrical conductor according to one or more illustrative aspects of the disclosure. At step 900, a heat-sensing device is configured. The heat sensing-device may be a thermocouple, LHD or similar heat-detection device. Configuring the heat-sensing device may include one or more design steps. For example, if the heat-detection device is an LHD, configuring the device may include selecting insulation which melts at an appropriate temperature. If the heat-detection device is thermocouple device, configuring the device may include coupling the device to a controller and setting a threshold temperature which the controller may interpret as a potentially unsafe temperature. At step 901, the heat-sensing device may be deployed along with a conductor, in an integrated cable similar to or the same as integrated cable 800. Deploying the device may comprise physically connecting an integrated cable to other system devices, as part of construction of an electrical system such as a PV installation. Steps 902-904 may be similar to or the same as steps 102-104 of FIG. 1.

In some embodiments, it may be desirable to log temperature measurements during “normal” system operation, both to provide real-time operating information and to predict future system events. For example, referring back to FIG. 3, circuitry 302 may comprise a sensor 301 coupled over common bus 320 to memory device 309, communication device 303 and control device 305. The measurements measured by sensor 301 may be stored on memory device 309, processed by control device 305 and/or communicated to external memory or control devices via communication device 303. The measurements taken by sensor 301 and/or sensors/sensor interfaces 304 may be analyzed by one or more control/processing devices for statistical patterns which may enable early detection or prediction of potentially dangerous situations. Measurements taken by many sensors deployed in many devices may generate a large database of measurements. In some cases, measurements obtained from a system which later experienced an unsafe condition may be analyzed to detect trends which may be exhibited in similar systems and may be indicative of an upcoming unsafe condition.

A myriad of predictive modeling and/or detection techniques may be used to detect or predict unsafe conditions resulting from rising or high conductor temperature. A partial list includes Bayesian analysis, Machine Learning, Artificial Neural Networks (ANN), Regression Analysis and Maximum a-posteriori (MAP) testing. For example, in some embodiments, a linear regression may be used to model the relationship between temperature at a conductor location and other measurable system variables such as temperatures measured at other system locations, voltage and current levels, current harmonic content, solar irradiance and/or ambient humidity levels. In some embodiments, an ANN may be trained to emulate a nonlinear function and identify an upcoming instance of conductor overheating by being trained using historical system data measured prior to system safety events (e.g. overheating, fires, etc.).

As an illustrative, non-limiting example, historical data may suggest that if a temperature measured by a temperature sensor deployed 20 [cm] or less from a connection point is above 100° for 10 [sec] or longer, and temperature is rising at a rate of 1° C./sec or higher and the current flowing through the connection point is 10 [A] or higher, there is a significant probability of the connection point overheating and a fire starting. The actual thresholds may vary from system to system, and those given above are illustrative examples.

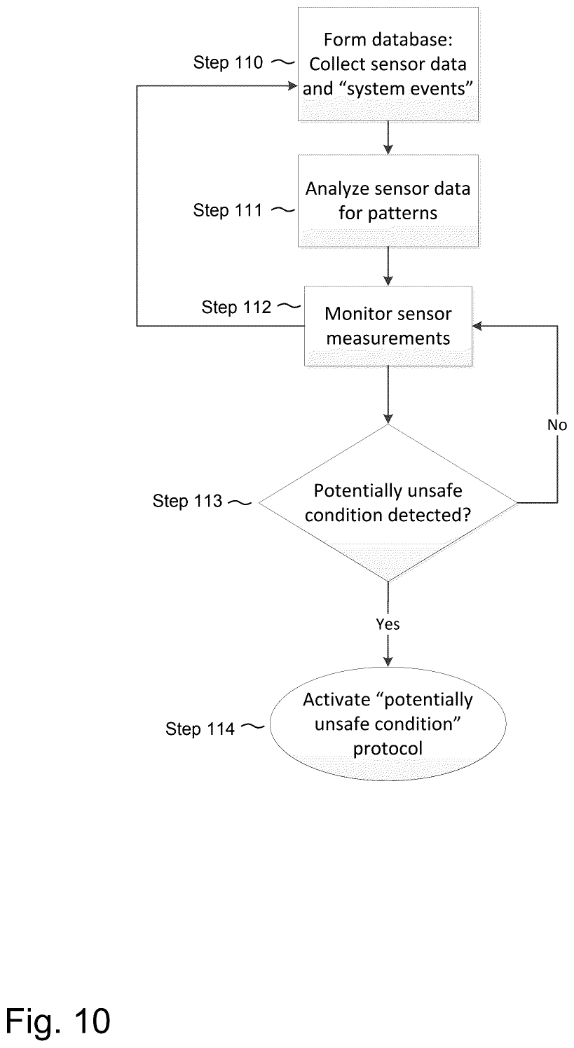

Reference is now made to FIG. 10, which shows a flowchart according to an aspect of illustrative embodiments. At step 110, data may be collected from sensors, and “system events” may be logged. Step 110 may take place over a period of time such as a day, month, year or several years. In some embodiments, step 110 may comprise purchasing data from a database. Sensor data may include (but is not limited to) measurements measured by voltage sensors, current sensors, irradiance sensors, temperature sensors, humidity sensors, and/or wind sensors. System events may include periods of normal, safe operating conditions, and may also include (but are not limited to) unsafe conditions such as arcing, overheating, fires, system failure and/or short-circuit conditions. At step 111, the data may be analyzed for patterns, using pattern recognition methods designed to correlate groups of data measurements with certain system events. Pattern recognition methods may include supervised and unsupervised learning methods, and may include various families of statistical and/or machine learning techniques.

At step 112, the method begins monitoring system sensor measurements. Measurements may be interpreted with regard to the patterns detected at step 111. In some embodiments, the method may proceed to step 113 each time a new sample is received, and in some embodiments may proceed to step 113 at regular time intervals, or after a series of samples is received. In some embodiments, measurements obtained at step 112 may be added to the system database, and the method may periodically return to steps 110-111, adding recent samples to the collection of sensor data and iteratively analyzing the collection of sensor data for recognizing patterns.

At step 113, the method may evaluate the system state based on previous measurements and a model developed for characterizing the system. For example, the method may determine that a temperature measurement of 100° C. measured by a temperature sensor (e.g. temperature sensor 401 or FIG. 4) indicates that the system may be in a potentially unsafe condition. As another example related to the illustrative embodiment illustrated in FIG. 4, the method may determine that a temperature measurement of 90° C. by temperature sensor 401, in combination with a previous temperature measurement of 85° C. by sensor and a current measurement of 10 [A] flowing through connector 408a (measured by, for example, a current sensor comprising circuitry 402) may indicate a potentially unsafe connection between connector 408a and a corresponding connector.

If, at step 113, the system is determined to be operating safely, the method may return to step 112 for continued monitoring of sensor measurements. If a potentially unsafe condition is detected at step 113, the method may proceed to step 114. At step 114, a “potentially unsafe condition” protocol may be followed. In some embodiments, the “potentially unsafe condition” protocol may comprise a controller automatically disconnecting a portion of the system from an electrical current. In some embodiments, the controller may be coupled via a communication device to a wired and/or wireless network(s)/Internet/Intranet, and/or any number of end user device(s) such as a computer, smart phone, tablet and/or other devices such as servers which may be located at a network operations center and/or monitoring center. These devices may be utilized to generate a warning of a dangerous condition, determine when a dangerous condition is probable, detect the type of dangerous condition and/or take action to degrade or turn off certain portions a system. These warnings can be audio and/or visual. They may, for example, be a beep, tone, siren, LED, and/or high lumen LED.

The method illustrated in FIG. 10 may be carried out by one or more control devices, either local or remote, with data-sharing and communication taking place between various control devices.

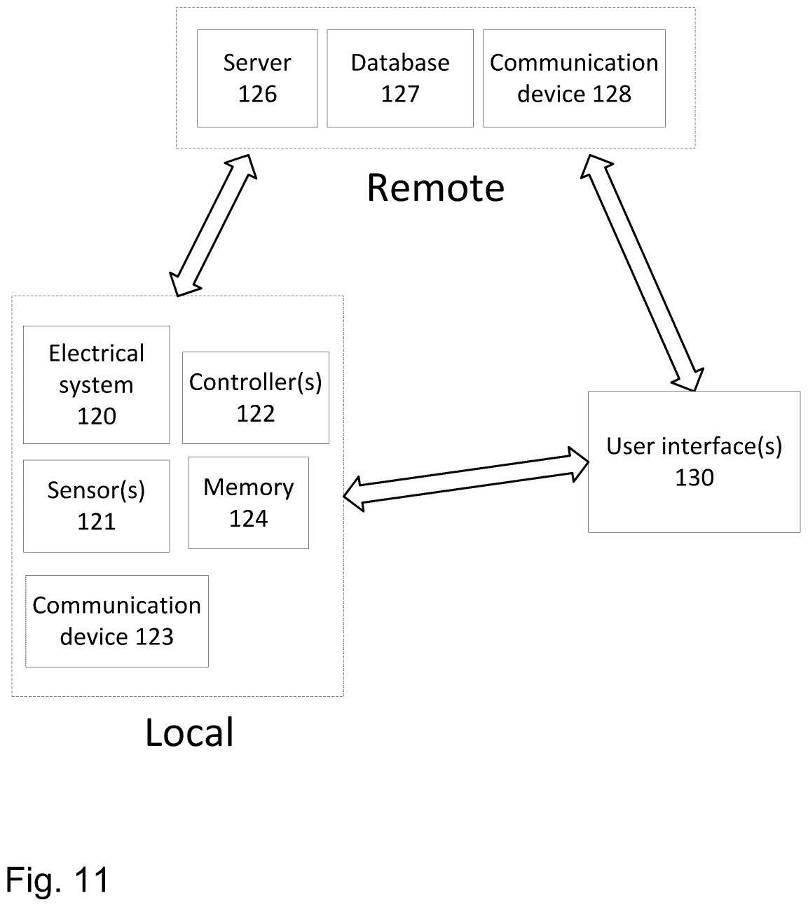

Reference is now made to FIG. 11, which illustrates a system control architecture according to an illustrative embodiment. Local electrical system 120 may be coupled to sensors/sensor interfaces 121, controller(s) 122, communication device 123 and local memory device 124. Interaction between the various local system devices may be similar to described above with regard to previously disclosed embodiments. Server 126, database 127 and communication device 128 may be remotely located, e.g. at a management, monitoring or command and control center. Communication devices 128 and 123 may be configured to communicate using wired or wireless communication methods, such as cellular communication, or using Power Line Communications. In some embodiments, the steps of the method of FIG. 10 are carried out solely by local controller(s) 122, and in some embodiments, the steps are carried out by both local controller(s) 122 and remote devices. For example, in some embodiments, steps 110 may be carried out by purchasing data and storing the data on database 127, step 111 may be carried out by server 126, step 112 may be carried out by local sensors/sensor interfaces 121 and controller(s) 122, step 113 may be carried out by server 126, and step 114 may be carried out by controller(s) 122. In some embodiments, step 110 may be carried out by sensors/sensor interfaces 121 taking measurements over time, and transferring the data to database 127 via communication devices 128 and 123. In some embodiments, at step 114, communication device 128 may send a warning to user interface(s) 130, reporting a potentially unsafe condition. In some embodiments, the entire method (steps 110-114) may be carried out by local devices.

In the illustrative embodiments disclosed herein, photovoltaic panels are used to exemplify energy sources which may make use of the novel features disclosed. In some embodiments, the energy sources may include solar shingles, batteries, wind or hydroelectric turbines, fuel cells or other energy sources in addition to or instead of photovoltaic panels. The temperature detection methods, prediction techniques and other techniques disclosed herein may be applied to alternative energy sources such as those listed above, and the nearly exclusive mentioning of photovoltaic generators as energy sources is not intended to be limiting in this respect.

It is noted that various connections are set forth between elements herein. These connections are described in general and, unless specified otherwise, may be direct or indirect; this specification is not intended to be limiting in this respect. Further, elements of one embodiment may be combined with elements from other embodiments in appropriate combinations or subcombinations. For example, integrated cable 800 of FIG. 8A may be used as an output conductor 404a of power device 400 or as output conductor 604a of PV panel 610. As another example, the architecture illustrated in FIG. 11 and described with regard to the method of FIG. 10 may also be used to implement all or part of the method of FIG. 1.

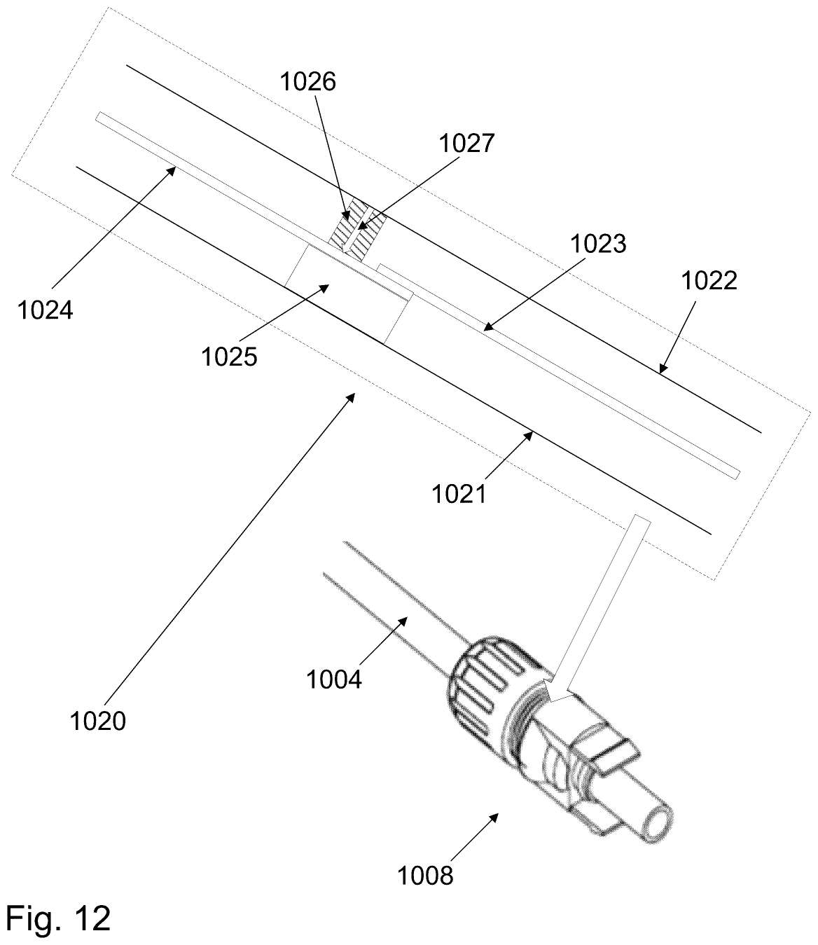

Reference is now made to FIG. 12, which illustrates an integrated thermal fuse 1020 according to aspects of illustrative embodiments. Integrated thermal fuse 1020 may be disposed between walls 1021 and 1022, and may comprise conductor 1023, conductor 1024, pellet 1025 and spring 1026. During normal operating conditions, conductors 1023 and 1024 may be in electrical contact for carrying current in a portion of a photovoltaic installation. Spring 1026 may be compressed between wall 1022 and conductor 1024, and may apply mechanical force to conductor 1024, in the direction indicated by arrow 1027. Pellet 1025 may be disposed between conductor 1024 and wall 1021, preventing or limiting movement of conductor 1024. Walls 1021 and 1022 may be portions of an electrical connector, for example, two sides of connector 1008, which may be the same as or similar to connectors 408a or 408b of FIG. 4. Connector 1008 may be a photovoltaic module connector, for example, a photovoltaic generator connector or a photovoltaic power device connector. In some embodiments, walls 1021 and 1022 may be sides of an electrical conductor such as conductor 1004, which may be the same as or similar to output conductors 404a and 404b of FIG. 4. Pellet 1025 may be conductive or nonconductive, and may be made of various materials or compound material including elements such copper, tin, silver, beryllium, or ferrite. Pellet 1025 may be selected to have a melting temperature in a range appropriate for disconnecting a circuit according to the safety requirements of the installation the fuse is disposed in. For example, in photovoltaic installations where it is desirable to disconnect a circuit in response to a temperature of 200° C. at a connection point, a pellet 1025 which melts or is deformed at approximately 200° C., or in a range around, slightly above or slightly below 200° C., may be used. As discussed with regard to FIG. 1, a different threshold may be selected depending on the flammability of materials near a connection point where thermal fuse 1020 may be deployed. Spring 1026 may similarly be conductive or nonconductive.

If the temperature in or at integrated thermal fuse 1020 reaches a temperature threshold selected to trigger a circuit disconnect, pellet 1025 may melt, break or be disfigured. Upon pellet 1025 melting, breaking or being disfigured, spring 1026 may decompress in the direction indicated by arrow 1027, forcing apart conductors 1023 and 1024, resulting in an open circuit connection.

It is to be understood that many different mechanical constructions of a thermal fuse may be considered for use as part of an integrated thermal fuse. For example, alternative constructions may include a conductive pellet forming part of a current path, the pellet melting at a predetermined threshold temperature and disconnecting the current path. As another example, a conductive spring may form part of a conduction path and may be compressed against a pellet, whereby upon the melting or disfiguration of the pellet, the spring decompresses and springs out of the conduction path. As yet another example, spring 1026 may be extended rather than compressed, with pellet 1025 disposed alongside spring 1026 and preventing compression of spring 1026, wherein under a high temperature, pellet 1025 may break or become deformed, allowing spring 1026 to compress and separate conductors 1023 and 1024. A person skilled in the art may appreciate various alternative constructions encompassed in embodiments described herein with regard to integrating a thermal fuse in a connector or cable for use in a renewable energy production installation.

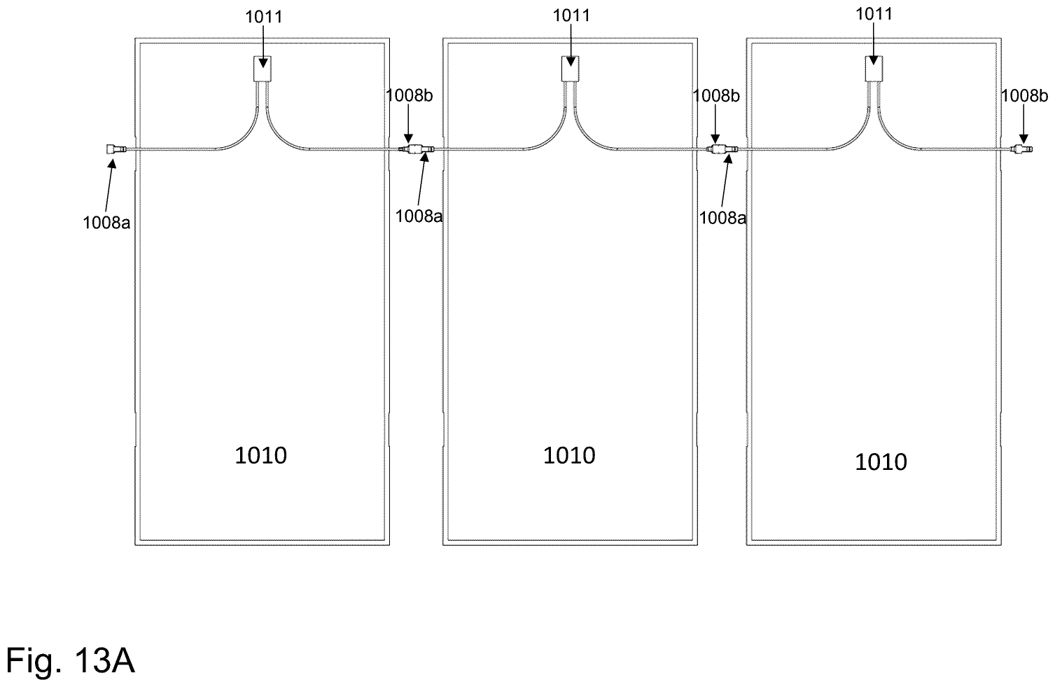

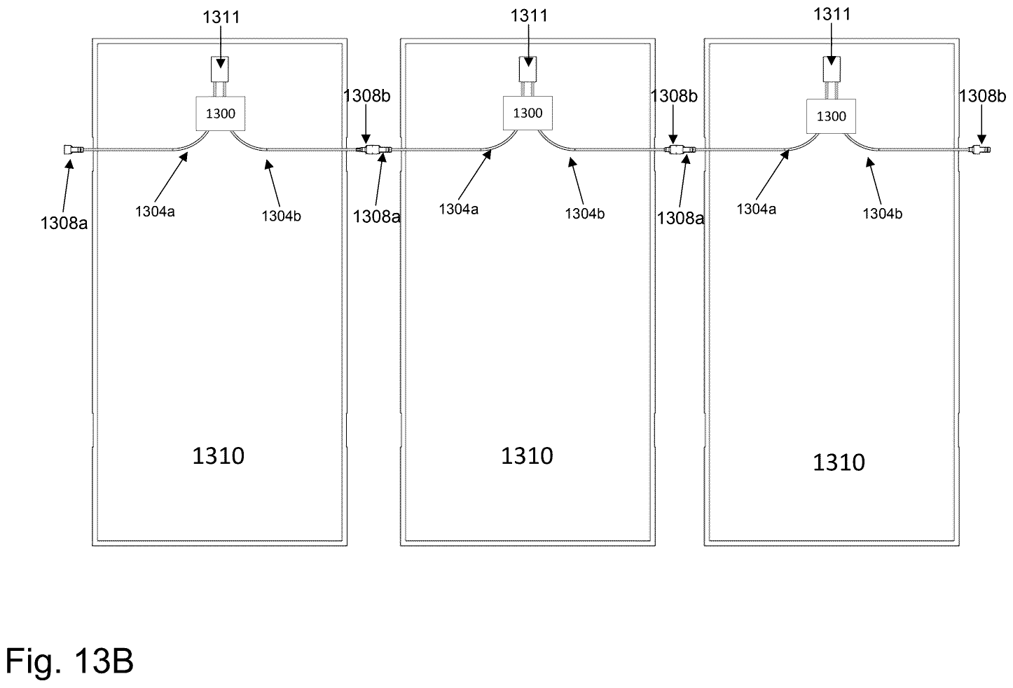

Reference is now made to FIG. 13A, which illustrates a portion of a photovoltaic string according to illustrative embodiments. Photovoltaic generators 1010 may be coupled in series to form a portion of a serial photovoltaic string. Each photovoltaic generator 1010 may comprise junction box 1011, each junction box 1011 comprising a first output conductor terminated by male connector 1008a and a second output conductor terminated by female connector 1008b. Each male connector 1008a may be designed to be connected to a female connector 1008b. In some embodiments, the locations of male connector 1008a and female connector 1008b on a junction box 1011 may be reversed or modified without departing from the scope of the present disclosure. Junction box 1011 may comprise conductors for receiving electrical power from junction box 1011 and outputting the electrical power via the first and second output conductors. In some embodiments, junction box 1011 may comprise a power converter (e.g. a DC-to-DC converter, or a DC-to-AC inverter such as a microinverter), the converter configured to adjust the converter input voltage and/or current to increase power drawn from junction box 1011. In some embodiments, a power converter embedded in junction box 1011 may include a Maximum Power Point Tracking (MPPT) circuit, configured to increase the power produced by junction box 1011. In some embodiments, junction box 1011 may comprise circuitry and/or devices depicted and described in FIG. 3, for example, sensor(s) 304, communication device 303 and/or safety device(s) 307.

Male connector 1008a and/or female connector 1008b may comprise an integrated thermal fuse similar to or the same as integrated thermal fuse 1020. In some embodiments, a thermal fuse may be integrated in a male connector, and in some embodiments, a thermal fuse may be integrated in a female connector, providing an integrated thermal fuse at each male-female connection point. In case of an overtemperature condition (e.g. due to a faulty connection between connectors) at a connection point, the integrated thermal fuse may trip, disconnecting the photovoltaic string and preventing a continuing rise in temperature at the connection point.

Integrating thermal fuses (e.g. integrated thermal fuse 1020) into photovoltaic connectors may increase safety in photovoltaic installations. The number and frequency of fires caused by faulty connectors or a faulty connection may be dramatically reduced by utilizing photovoltaic panels (either with or without junction-box embedded DC-DC or DC-AC converters), photovoltaic converters, batteries and/or other system devices with built-in thermal safety fuses to prevent temperatures from rising above a predetermined threshold such as 200° C.

Reference is now made to FIG. 13B, which illustrates a portion of a photovoltaic string according to illustrative embodiments. Photovoltaic generators 1310 and junction boxes 1311 may be similar to or the same as photovoltaic generators 1010 and junction boxes 1011 of FIG. 13A. Photovoltaic power devices 1300 may be similar to or the same as photovoltaic power device 400 of FIG. 4, and may be retrofitted to photovoltaic generators 1011. In some embodiments, photovoltaic power device 1300 may comprise two output conductors 1304a and 1304b, which may be about the same length. Each conductor 1304a may be terminated by a male connector 1308a and each conductor 1304b may be terminated by a female connector 1308b. Each male connector 1308a or each female connector 1308b may be similar to or the same as male connector 1008a and female connector 1008b of FIG. 13A. For example, each male connector 1308a or each female connector 1308b may comprise an integrated thermal fuse designed to respond to an overtemperature condition and disconnect two photovoltaic devices 1300.

Reference is now made to FIG. 13C, which illustrates a portion of a photovoltaic string according to illustrative embodiments. Photovoltaic generators 1320 may be coupled in parallel to form a portion of a parallel photovoltaic string. Each photovoltaic generator 1320 may comprise junction box 1321, and may be connected between a ground bus and a power bus. Photovoltaic generators 1320 and junction boxes 1321 of FIG. 13C may be the same as photovoltaic generators 1010 and junction boxes 1011 of FIG. 13A. The ground bus and power bus may comprise first splice connector 1012a and second splice connector 1012b for providing an electrical connection to a photovoltaic generator. For example, the power bus may provide a plurality of second splice connectors 1012b, each second splice connector 1012b designed to be connected to a photovoltaic generator female connector (e.g. female connector 1008b of FIG. 13A). Similarly, for example, the ground bus may provide a plurality of first splice connectors 1012a, each splice connector 1012a designed to be connected to a photovoltaic generator male connector (e.g. male connector 1008a of FIG. 13A). In some embodiments, a thermal fuse (e.g. integrated thermal fuse 1020) may be integrated into first splice connector 1012a and/or second splice connector 1012b, the thermal fuse designed to disconnect a photovoltaic generator from the splice connector upon an increase in temperature in our next to the thermal fuse, to prevent a faulty connection from causing a fire or other dangerous situation.

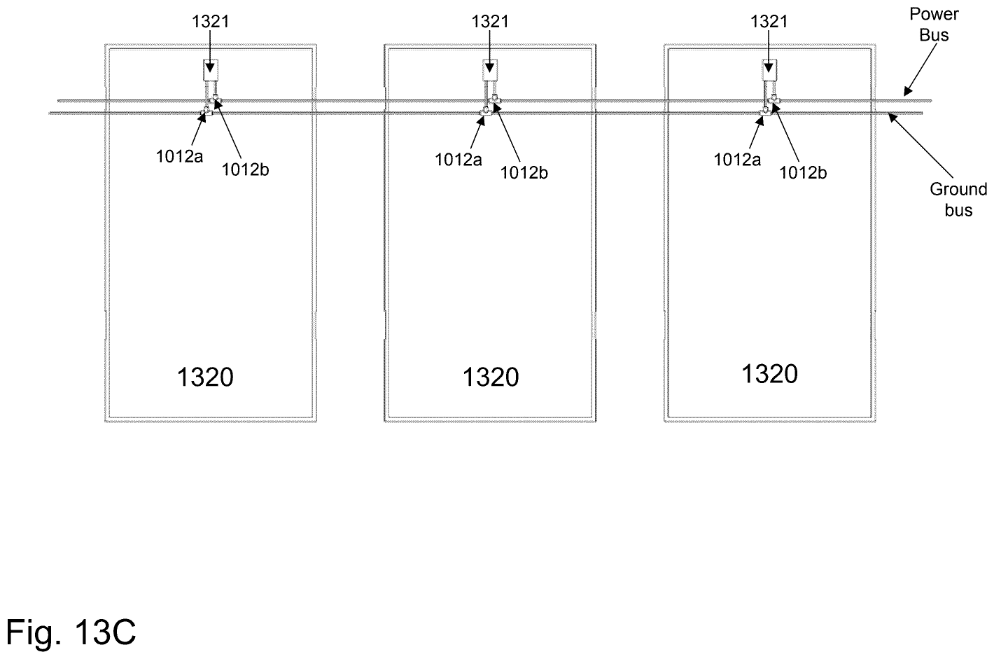

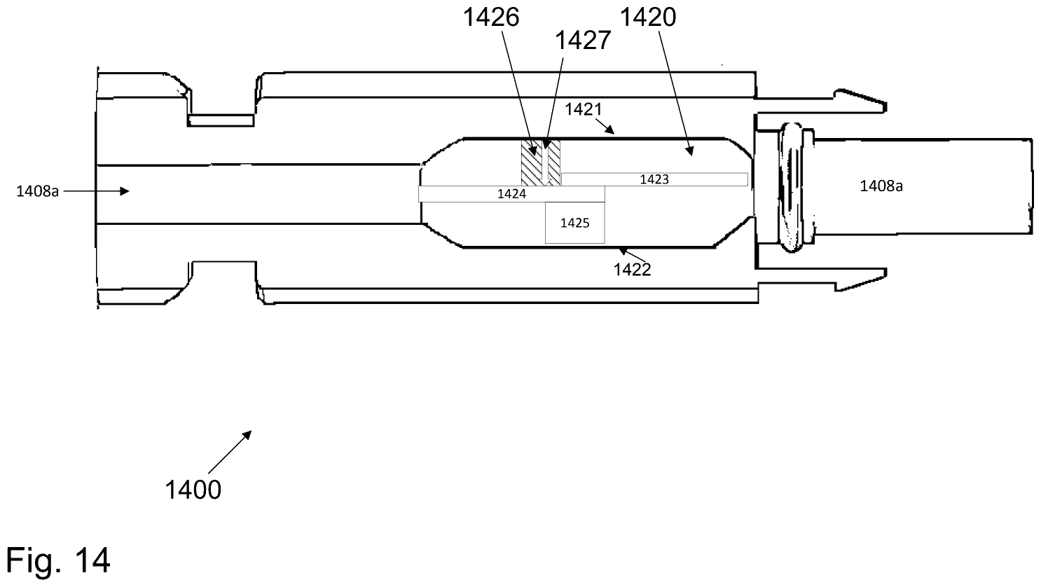

Reference is now made to FIG. 14, which illustrates a thermal fuse connector 1400 according to illustrative embodiments. Thermal fuse connector 1400 may comprise male connector 1408a, female connector 1408b and thermal fuse therebetween. Thermal fuse 1420 may comprise conductors 1423 and 1424, and conductors 1423 and 1424 may provide a conductive path between male connector 1408a and female connector 1408b. Spring 1426 may be compressed between wall 1421 and conductor 1424, and may apply mechanical force to conductor 1424, in the direction indicated by arrow 1427. Pellet 1425 may be disposed between conductor 1424 and wall 1422 of thermal fuse 1420, preventing movement of conductor 1424. Pellet 1425 may be conductive or nonconductive, and may be made of various materials or compound material including elements such copper, tin, silver, beryllium, or ferrite. Pellet 1425 may be selected to have a melting temperature appropriate for disconnecting a circuit according to the safety requirements of the installation the fuse is disposed in. For example, in photovoltaic installations where it is desirable to disconnect a circuit in response to a temperature of 200° C. at a connection point, a pellet 1425 which melts or is deformed at about 200° C., or in a range around or slightly below 200° C., may be used. Spring 1426 may similarly be conductive or nonconductive.

Male connector 1408a may be designed to be connected to a female connector of a photovoltaic generator, such as female connector 1008b of FIG. 13A. Female connector 1408b may be designed to be connected to a male connector of a photovoltaic generator, such as male connector 1008a of FIG. 13A.

Referring back to FIG. 13A, some photovoltaic generators may have been already constructed using photovoltaic generators which do not include integrated thermal fuses. It may be desirable to add thermal fuses to existing systems, and/or to add thermal fuses to existing photovoltaic generators. Thermal fuse connector 1400 may be connected to existing photovoltaic generators or systems by connecting male connector 1408a to female connector 1008b of a photovoltaic generator, and connecting female connector 1408b to a male connector 1008a of a different photovoltaic generator. Similarly, thermal fuse connector 1400 may be connected to batteries, power converters, combiner boxes or other photovoltaic devices featuring connectors similar to male connector 1008a and female connector 1008b.

Reference is now made to FIG. 15, which shows a method for operating a power converter according to illustrative embodiments. Method 1500 may be carried out by a controller (e.g. a Digital Signal Processer, Application-Specific Integrated Circuit, Field Programmable Logic Array, Microcontroller, and the like) configured to control a photovoltaic (PV) power device. At step 1501, the PV power device receives photovoltaic power at the device inputs. In some embodiments, the PV power device may receive photovoltaic power directly from a photovoltaic generator. In some embodiments, the PV power device may receive photovoltaic power from a group string of photovoltaic generators connected in series or in parallel, or may receive photovoltaic power combined in a combiner box. At steps 1502 and 1503, the PV power device may convert the power received at the input to power provided at the device output, and provide the converted power to output terminals, respectively. In some embodiments, the conversion may be from a direct current (DC) voltage to a DC voltage of the same or a different magnitude. In some embodiments, the conversion may be from direct current (DC) to alternating current (AC). In some embodiments, conversion might not take place, with input power being transferred as-is to the output. At step 1504, the controller may check for an open circuit condition at the device output. For example, a current sensor may measure output current, with a low measurement indicating a possible open circuit. An open circuit condition may be caused by a thermal fuse (e.g. a thermal fuse embedded in first connector 1008a or second 1008b of FIG. 13A, or a thermal fuse in a thermal fuse connector 1400) being tripped by an overtemperature condition. If no open-circuit condition is detected, the controller may return from step 1504 back to step 1501 and continue receiving photovoltaic power at the input.

If a potential open-circuit condition is detected (i.e. a thermal fuse may have tripped), the controller may proceed from step 1504 to step 1505 and reduce the power received at the input. For example, the controller may control switches to disconnect the input from a source of photovoltaic power (resulting in zero input current) or to short-circuit the input to the power device (resulting in zero input voltage). In some embodiments, step 1505 may include reporting the open-circuit condition and safety measures taken to a centralized control and/or data center.

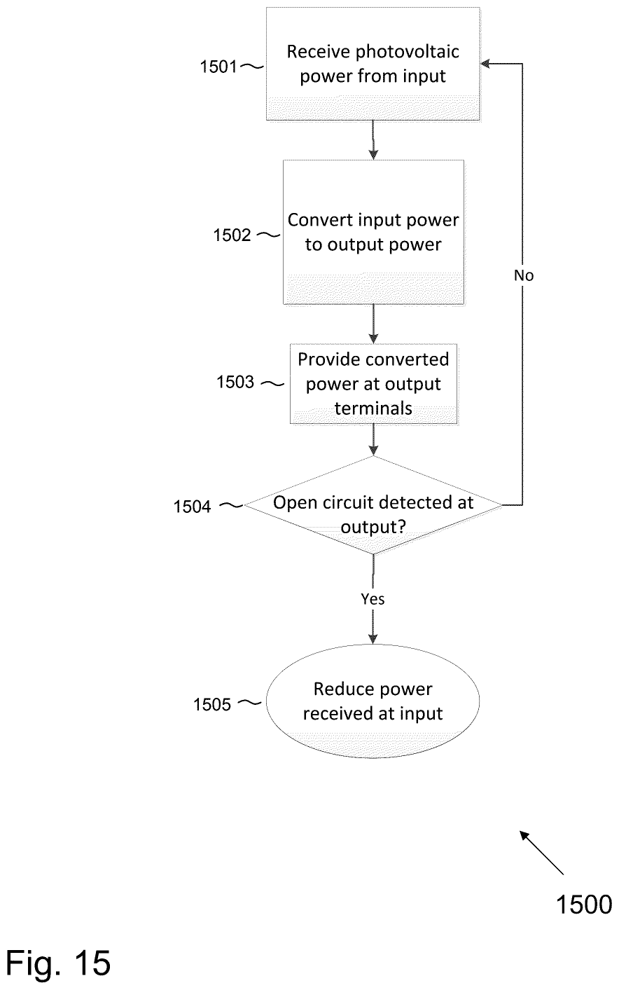

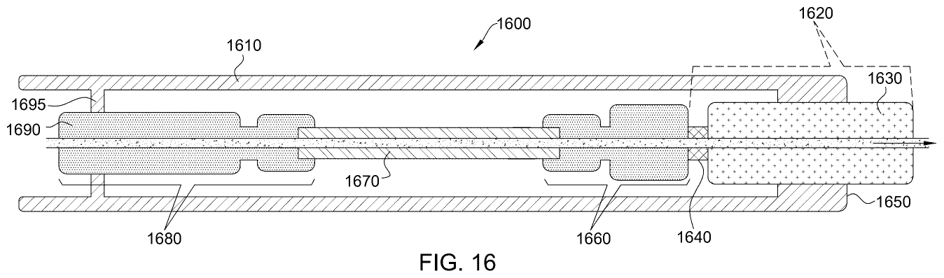

Reference is now made to FIG. 16, which shows an illustration of a connector assembly 1600 including thermal fuse 1670. The design of the connector assembly 1600 is not limiting, and, as will be seen below, additional designs and implementations of connectors and thermal fuses will be discussed. First connector assembly 1600 may be bound by a connector housing 1610, which may be, for example, cylindrical in shape. Other shapes of the housing 1610 may include a generally rectangular box shape, in which case, each face of the generally rectangular box (i.e., a cuboid) shape may be viewed as a different wall of housing 1610. In another implementation, the housing 1610 may be generally cone-like, namely, wider at a first end, and gradually narrowing to the second end. Additionally, the housing 1610 may have any other appropriate shape, including, but not limited to other regular shapes, e.g., a triangular prism, a pyramid, and so forth, as well as various irregular three-dimensional shapes.

A cable 1620, comprising an insulating layer 1630 on the outside of the cable 1620 and a length 1640 of conducting material, e.g., copper or aluminum, disposed inside the insulating layer 1630, may enter the connector housing 1610 at a first end 1650. Note that throughout the present specification and accompanying drawings, various lengths of conducting material may be described as being inside an insulating layer, even if, in places, for ease of depiction, said lengths of conducting material may be, in some places, depicted as entering or next to said insulating layer. At an end of the cable 1620, the insulating layer may be absent (e.g., may be stripped away), leaving the length 1640 of conducting material exposed inside the connector housing 1610, as depicted in FIG. 16. A connection, such as a crimp 1660, may be formed with the length 1640 of conducting material at the stripped end of the cable 1620. The connection formed by the crimp may be, in some implementations, a solderless connection. In other implementations, the connection 1660 may be a soldered connection, or a screw connection. The crimp 1660 may be replaced by any other appropriate conductive material which provides an electrical connection to the length 1640 of conducting material, and may be implemented as described herein. The crimp 1660 may enable connecting the length 1640 of conducting material without solder, which may reduce the effect of corrosion on a joint which could otherwise be a soldered joint, as well as providing an increase in the mechanical stability of the cable, as solder tends to be more prone to mechanical degradation (e.g., due to mechanical or thermal overstressing, poor wetting, wicking along the conducting material, etc.) than the crimp 1660. A second end of the crimp 1660 may be connected to a length of material which serves as the thermal fuse 1670 itself.

Typically, the thermal fuse 1670 comprises a low melting temperature alloy. By way of example, the thermal fuse 1670 may have a melting point between 50° C.-300° C. In some implementations, the thermal fuse 1670 may have a melting point below 200° C. The thermal fuse may be designed in an application specific manner, such that an alloy used in the fuse may be selected based on an expected temperature at anticipated or specified operating currents. By way of example, in a system where an anticipated or specified operating current is 4 A, then the thermal fuse may be designed (e.g., selection of the metal or alloy used in and/or the dimensions of the thermal fuse) dependent on an anticipated operating temperature at a current of 4 A (plus some tolerance and/or margin of error). In a system where an anticipated or specified operating current is 8 A, then the fuse may be designed (i.e., selection of the metal or alloy used in and the dimensions of the thermal fuse) dependent on an anticipated operating temperature at a current of 8 A (plus some tolerance).

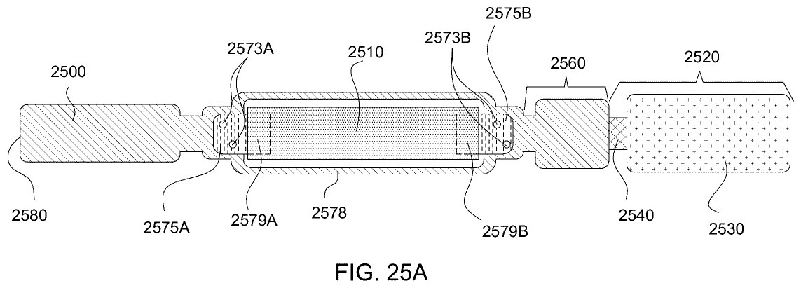

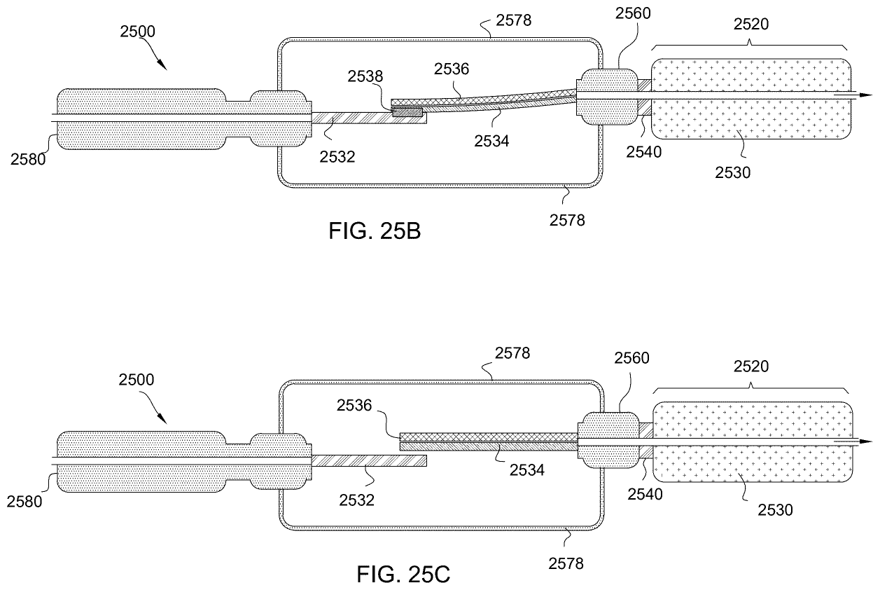

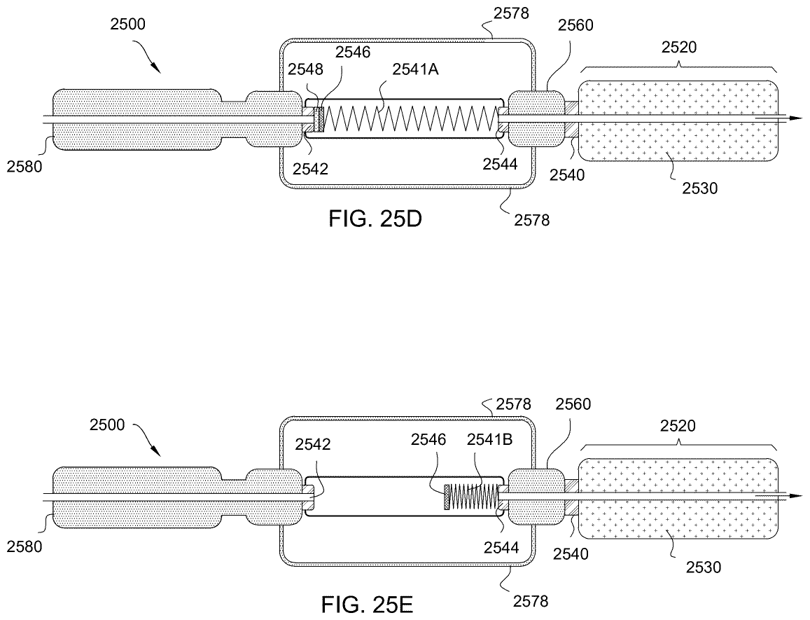

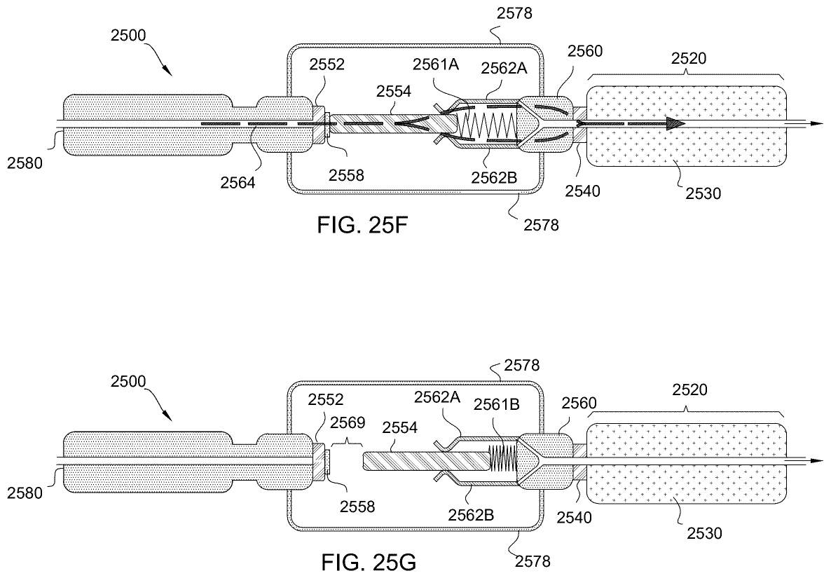

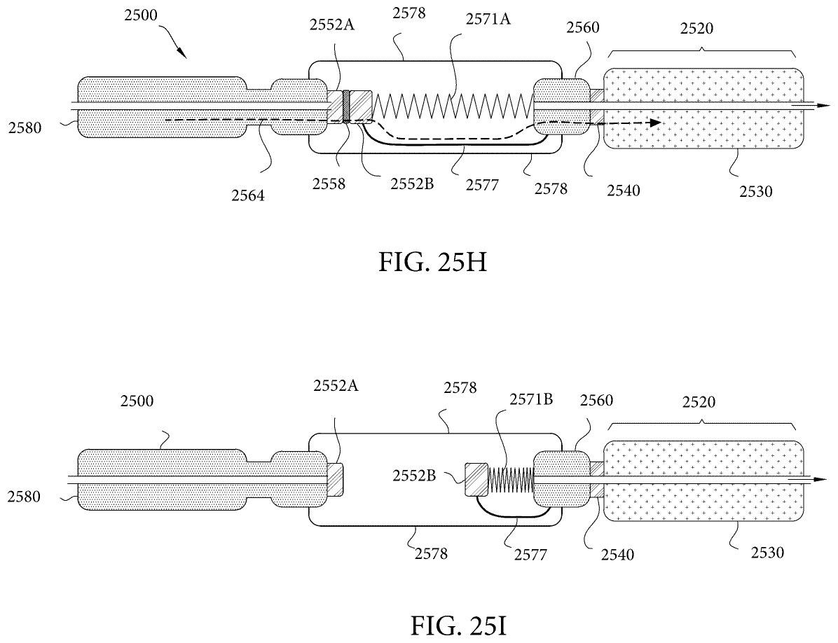

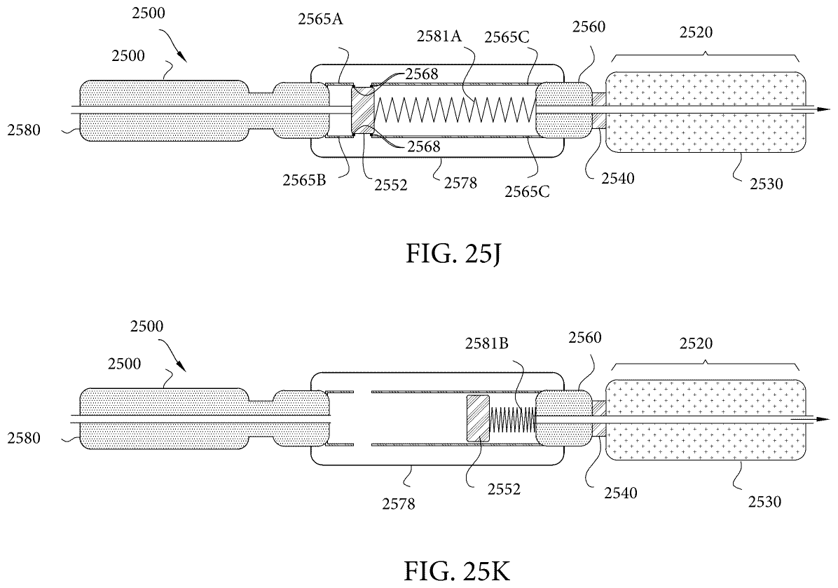

The thermal fuse 1670 may, at a second end, connect to a first end of a metallic connector pin 1680. A second (exposed) end 1690 of connector pin 1680 may exit a second end 1695 of the connector housing 1610. The connector pin 1680 may not be disposed within the connector housing (and not depicted in FIG. 16, but see FIG. 25A). The exposed end 1690 of connector pin 1680 may be configured to contact a second connector pin or socket of a coupling connector. For example, the exposed end 1690 of connector pin 1680 may be designed to easily connect to a second connector pin (not depicted) at a second exposed end (of the second connector pin), either by snapping to the second (exposed) end of the second connector pin, screwing to the exposed end 1690, or other appropriate techniques of forming a connection. The cable 1620, the length 1640 of conducting material, the fuse 1670, and the connector pin 1680 may comprise a conducting path. The conducting path may be interrupted if the thermal fuse 1670 breaks, deforms, melts, etc., and is no longer forming a portion of the conducting path.

Reference is now made to FIG. 17, which shows a cross-section of a connector 1700, such as a connector 1700 which might be used in or with a photovoltaic module for generation of electricity. It is appreciated that the above mention of the photovoltaic module for generation of electricity is by way of example, and other appropriate uses of the connector 1700 are not mentioned here for simplicity and as a matter of convenience. A cable 1720 may enter a housing 1710 at a first end 1750 of the housing 1710. The cable 1720 may be covered with an insulating layer 1730, the same as or similar to the insulating layer 1630 of the cable 1620 of FIG. 16. Within the volume bounded by the housing 1710, a length 1740 of conducting material of the cable 1720 may be exposed (e.g., not covered by the insulating layer 1730), similar to the exposed length 1640 of conducting material of FIG. 16 inside the housing 1610. The length 1740 of conducting material of the cable 1720 may terminate at a first end crimp 1760, similar to crimp 1660 of FIG. 16. A second end of crimp 1760 may be attached to, or form a part of, a connector pin 1780, similar to or the same as connector pin 1680. The connector pin 1780 may be formed, by way of example, by progressive stamping. Other appropriate manufacturing techniques may be used instead of or in addition to progressive stamping when forming the connector pin 1780 and the connector pin 1680. For example, the connector pin 1780 and the connector pin 1680 may be formed by machining, casting, extrusion, deep drawing, stamping, together with metal plating. The metal printing connector pin 1780 and the connector pin 1680 may also be formed by 3d metal printing techniques, including, but not limited to direct metal laser sintering (DMLS) direct metal laser melting (DMLM), and other appropriate 3d metal printing techniques.

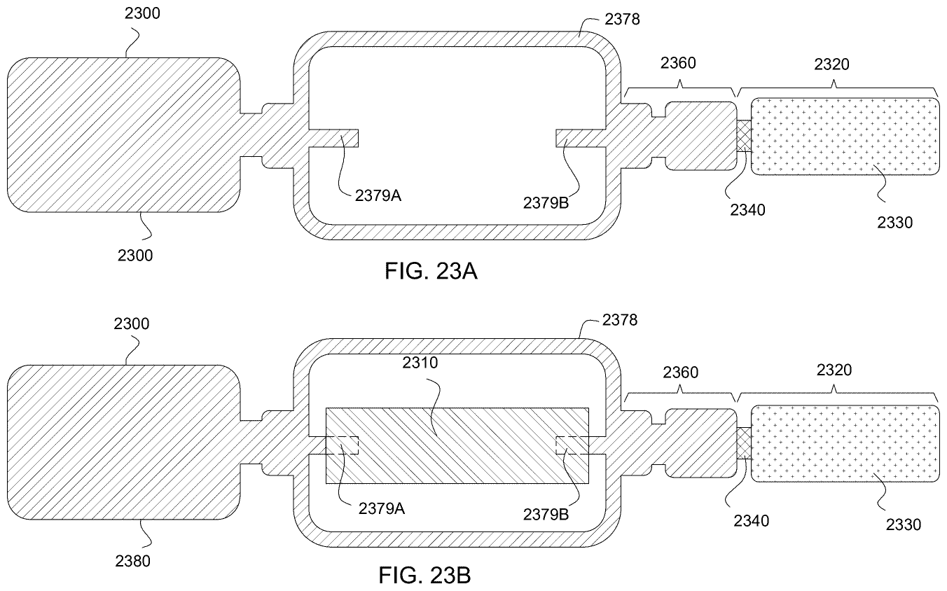

The progressive stamping which forms the connector pin 1780 may include a metalworking technique that may encompass punching, coining, bending and various other ways of mechanically forming metal raw material, and may be combined with an automatic feeding system where the metal raw material is inserted into a stamping apparatus. Similar to the connector assembly 1600 of FIG. 16, the cable 1720, the length 1740 of conducting material of the cable 1720, the crimp 1760 and the connector pin 1780 may comprise a conducting path. The connector pin 1780 may terminate at an exposed end 1790. The exposed end 1790 may exit the housing 1710 at a second end wall 1795 of the housing 1710. A connection to a second connector, which may be the same as or similar to connector 1700 and/or any other connector described herein, may be formed in some cases by snapping, screwing, or other appropriate techniques of connecting two connectors. In other cases, the exposed end 1790 of the connector 1700 may be forced into place and held in place by pressure. Various examples of connecting the connector 1700 and the housing 1710 are given below, with reference to FIGS. 23A-25A.

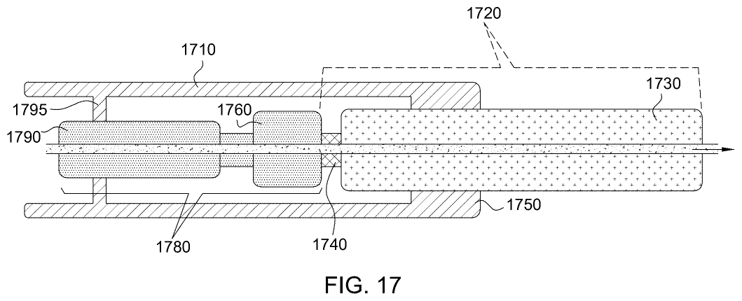

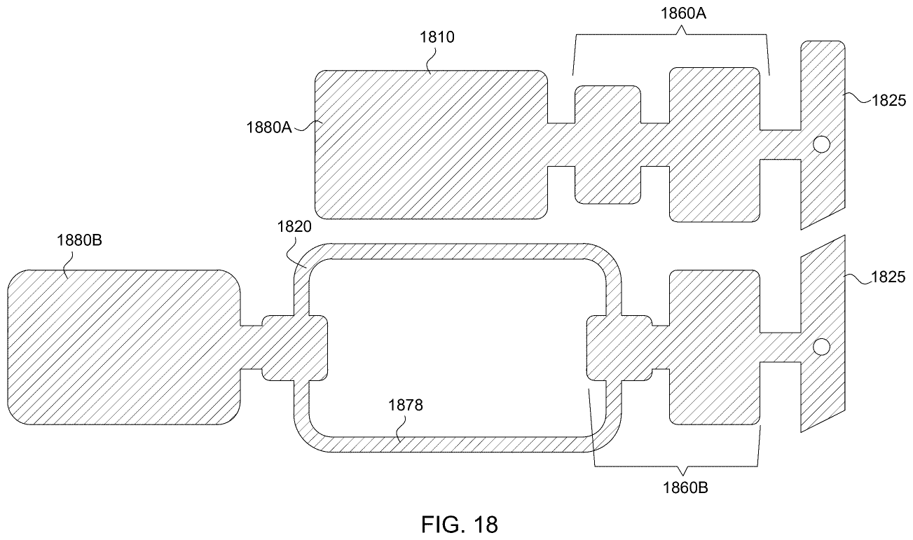

Reference is now made to FIG. 18, which shows various designs for a phase in a stamping process for manufacturing the connector pin 1680 and/or crimp 1660 (FIG. 16) and connector pin 1780 (FIG. 17) for use in thermal fuse assemblies, and similar applications. In the description of FIG. 18, elements such as “connector pin” and “crimp” may be in an unfinished state. Nonetheless, for ease of description, they are referred to as they would be when finished. A first connector pin 1880A (e.g., 1780) is depicted in FIG. 18 as a portion of metal blank 1810. A second connector pin 1880B (e.g., 1680) is depicted in FIG. 18 as a portion of metal blank 1820. The first metal blank 1810 is distinguished from the second metal blank 1820 by the presence of a window, formed by frame 1878. The window, formed by frame 1878 is provided so that, for example, a thermal fuse, such as the thermal fuse 1670 of FIG. 16, may be disposed within the metal blank 1820 between 1880B and 1860B. The first metal blank 1810 and the second metal blank 1820 may be formed by progressive stamping, as described above with reference to FIG. 17. A metal sheet, such as, by way of a non-limiting example, tinned copper foil having a thickness of about 0.4 mm, may be subjected to the progressive stamping. The metal sheet may also be, for example, tinned brass, tinned bronze, or a tinned alloy of copper.

When the first metal blank 1810 and the second metal blank 1820 are formed during progressive stamping, a strip of metal 1825 having a hole may remain. The hole may serve as a guide during the process of progressive stamping, so that a plurality of the first metal blank 1810 and the second metal blank 1820 may be fed through the progressive stamping apparatus as part of the process of forming the first metal blank 1810 and the second metal blank 1820. The strip of metal 1825, may be removed after the progressive stamping process, as it is needed for the progressive stamping process, but not for the actual first metal blank 1810 and second metal blank 1820.

A crimp 1860A, which may be the same as or similar to the crimp 1760 of FIG. 17, is formed during the progressive stamping process. A crimp 360B, which may be the same as or similar to the crimp 1660 of FIG. 16, is formed during the progressive stamping process. A connector pin 1880A, which may be the same as or similar to the connector pin 1780 of FIG. 17 is formed during the progressive stamping process. A connector pin 1880B, which may be the same as or similar to the connector pin 1680 of FIG. 16 is formed during the progressive stamping process.

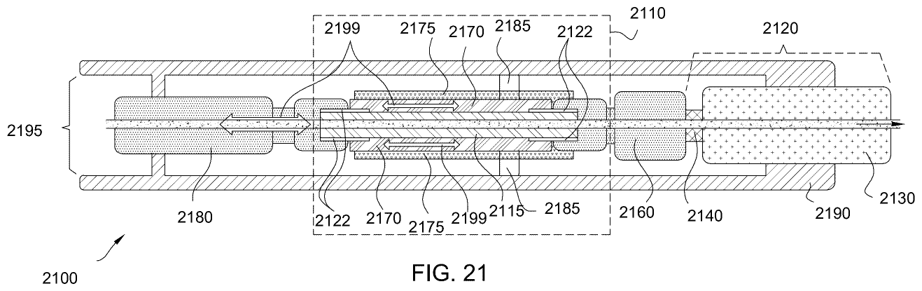

As part of the progressive stamping process, the metal blank 1810 and the second metal blank 1820 may be folded so as to form a generally cylindrical shape. For example, and with additional reference to FIG. 21, below, the second metal blank 1820 may be folded to form a loosely cylindrical shape, where the connector pin 1880B of FIG. 18 generally corresponds to the connector pin 680.

It is appreciated that the stamping process described herein above for forming the connector pins 1680 and 1780 may be adapted to other appropriate connectors, or other apparatus.

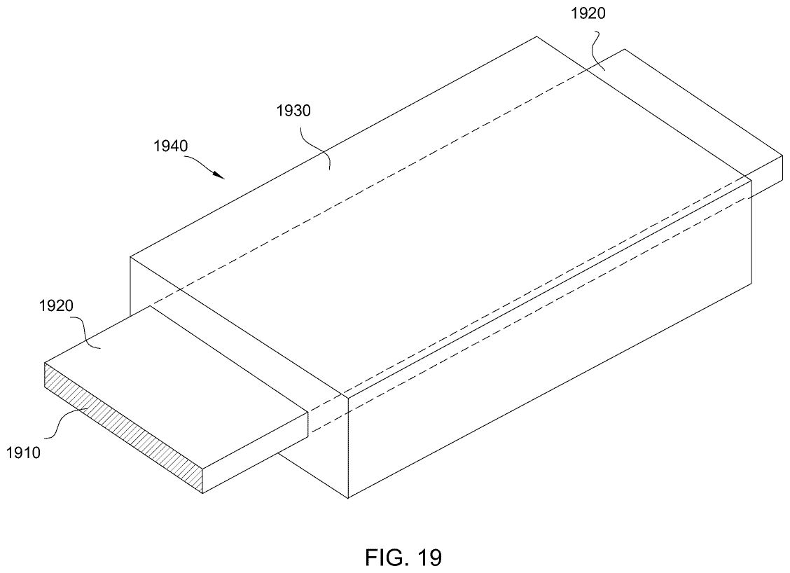

Reference is now made to FIG. 19, which shows an isometric view of a thermal fuse 1900. Thermal fuse 1900 of FIG. 19 may be the same as, or substantially similar to the thermal fuse 1670 of FIG. 16. A core 1910 may be entirely surrounded by a copper layer 1920 (at either end of the thermal fuse 1900). The copper layer 1920 may function as a terminal, as will be described below with reference to FIG. 21. The two copper layers 1920 and the core 1910 form a generally bar shaped member. A conducting portion (e.g., metallic alloy) 1930 having a low melting point, which may be an alloy or a non-alloyed metal, overlays the core 1910. (The core 1910 is displayed entirely surrounded at the portions extending beyond 1930 by a copper layer 1920). The copper layer 1920 may be exposed at either end of the thermal fuse 1900.

The core 1910 is provided for the thermal fuse 1900. The core 910 may be plastic or other appropriate non-conductive/electrically insulative material. The core 1910 serves as a base for the thermal fuse 1900 providing rigidity to the thermal fuse 1900. Additionally, the core 1910 serves as a base for metallic layers, to be described shortly. A copper layer 1920 is provided on the core 1910. A conducting portion (e.g., alloy) 1930, with a predetermined melting point (as will be discussed below), can be overlaid upon a base provided by the copper layer 1920 and core 1910. The conducting portion 1930 may be selected for particular implementations on a basis of a melting point based on particular implementation requirements and design specifications. The copper layer 1920 may cover the extremities (e.g., ends) of the core 1910, and may carry current between a length of a conducting material (e.g., 1760, 1780) to which the thermal fuse 1900 may be connected into a conducting portion (e.g., 1930) of the thermal fuse 1900. The electrically conducting portion 1930 of the thermal fuse 1900 may comprise a metal or metallic alloy typically having a melting point lower than the melting point of the copper layer 1920, or another typically metallic conductor, such as aluminum, in the length of the connected conducting material.

By way of some non-limiting examples, the conducting portion 1930 having a low melting point may comprise metals, alloys, or polymers. Metals and alloys may have a melting point between 50-300 deg. Celsius, such as the following, non-limiting examples:
Tin; (e.g., 231 degrees Celsius (degC.) melting point)
Tin and Bismuth alloys (approx. 150 degC. melting point),
Tin, Silver, and Copper alloys (e.g., tin 80-98%); (e.g., 220 degC. melting point) and
Tin, Iridium, and Bismuth alloys.

Other appropriate percentage combinations of metals may also be used (such as 80-100% Tin, 0-5% Silver, 0-1% copper) to adjust melting point temperature of each of these base alloys. Any other appropriate alloy with a melting point between 100-250 degC. may also be used. Such alloys will typically have a resistivity less than 1×10⁻⁵ Ωm. The remaining percentages will typically comprise other metallic elements with higher melting points, e.g., Copper (melting point 1065 degC.) or Aluminum (melting point 660 degC.).

Electrically conductive polymer materials may be used with appropriate melting point temperature (e.g., polyphenyl ether, with a melting point of 285 degC., polyphenylene oxide, with a melting temperature typically between 177-222 degC., or polyphenylene sulfide with a melting temperature of 275 degC.) may be used as the conducting portion 430 having a low melting point.

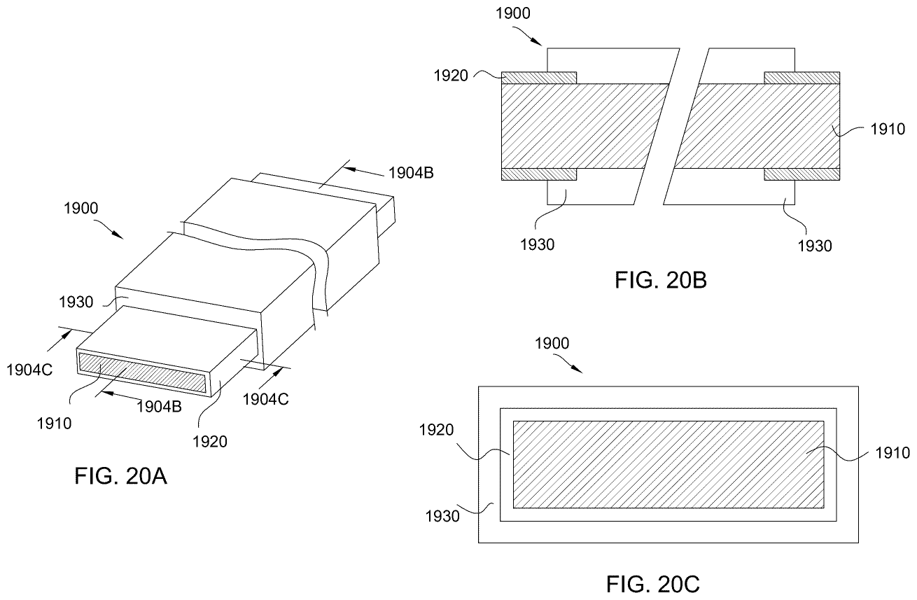

Examples of dimensions for the thermal fuse 1900 are now provided. The dimensions provided are not meant to exclude any other implementations. Rather, they are one possible set of dimensions (with reference to the example ranges of dimensions mentioned below in the description of FIGS. 20A-20C). By way of one example:

| Dimension | Example Length in mm (range) | |
|---|---|---|
| Length of thermal fuse 400 | 25 | (20-40) |
| Width of thermal fuse 400 | 5 | (4-7) |
| Height of thermal fuse 400 | 2 | (2-4) |
| Length of layer 420 | 3 | (2-5) |
| Width of layer 420 | 4 | (1-15) |
| Height of layer 420 | 0.6 | (0.1-4) |

Reference is now made to FIGS. 20A-20C, which show the thermal fuse 1900 in various views. FIG. 20A shows an isometric cross section view of the thermal fuse 1900. FIG. 20B shows a longitudinal cross section view of the thermal fuse. FIG. 20C shows a transversal cross section view of the thermal fuse. The thermal fuse 1900 is depicted in FIGS. 20A-20C as a generally elongated cuboid (i.e., a three-dimensional rectangle). As discussed above, with reference to FIG. 16, in other implementations, the thermal fuse 1900 may be configured in other appropriate shapes (e.g., cylindrical). Section views 20B and 20C are indicated in FIG. 20A by appropriate section linings, indicated, respectively, as 20B and 20C.

The thermal fuse 1900 may be disposed in series with an appropriate connector, for example, between the connector pin 1680 and crimp 1660 of FIG. 16 or between 1880B and 1860A in FIG. 18. By way of example, the cross-sectional area of the core 1910 may be between 2-9 mm², the plastic core length may be between 5-40 mm, and the thermal fuse may have a total resistance between 10-4000 μΩ, and a current capacity of 0-45 A.

Reference is now made to FIG. 21, which shows a first view of thermal fuse 2110 in a connector assembly 2100. The thermal fuse 2170 may be the same as or similar to the first thermal fuse 1670 of FIG. 16, as well as the thermal fuse 1900 of FIGS. 19 and 20A-20C. The connector assembly 2100 may be similar to or the same as the connector assembly 1600 of FIG. 16. Additionally, a connector pin 2180 and crimp 2160 of the connector 2100 may be formed by a progressive stamping method similar to that described with reference to the connector pin 1880B and crimp 1860B formed by progressive stamping of FIG. 18. A coating disposed on a core 2115 may comprise conducting portion 2170 having a low melting point. The core 2115 may correspond to the core 1910 of FIG. 19. The core may be formed of a non-conducting material, e.g., a plastic to which the metallic portion will adhere, when applied to the core 2115. A copper layer 2122 corresponding to copper layer 1920 of FIGS. 19 and 20 is shown at the extremes of core 2115. It is noted that the copper layer 2122 (and the copper layer 1920) may function to carry current into the conducting portion having the low melting point. Since the resistance of copper layer 2122 may have a lower resistance than conducting portion 2170, the copper layer 2122 does not cover the entirety of the fuse, thereby leaving the conducting portion 2170 as the remaining conducting path for electric current. While layers 1920 and 2120 are identified as copper, these layers may be any low surface contact resistance material with a lower resistance than conducting portion 2170.

A cable 2120, comprising an insulating layer 2130 on the outside of the cable 2120 and a length 2140 of conducting material inside the insulating layer 2130 may enter the connector housing 2190 at a first end. The cable 2120, the insulating layer 2130 and the length 2140 of conducting material may be the same as or similar to the cable 1620, the insulating layer 1630 and the length 1640 of conducting material of FIG. 16. A crimp 2160, which may be the same as or similar to the crimp 1660 of FIG. 16 is attached, at a first end, to the length 2140 of conducting material. The crimp 2160 may be attached at a second end to the copper layer 2122 coating one end of the thermal fuse assembly 2110.

A connector housing 2190 may provide an external boundary around the various elements described in FIG. 21. The connector housing 2190 itself may form a connector 2100 (which may correspond to connector housing 1610 of FIG. 16) which may attach, for example, to a second connector 2100, at one terminus 2195 of the connector 2100. Arrows 2199 indicate a conducting path in the connector 2100, via the thermal fuse 2110. Current may flow in either direction along the conduction path.

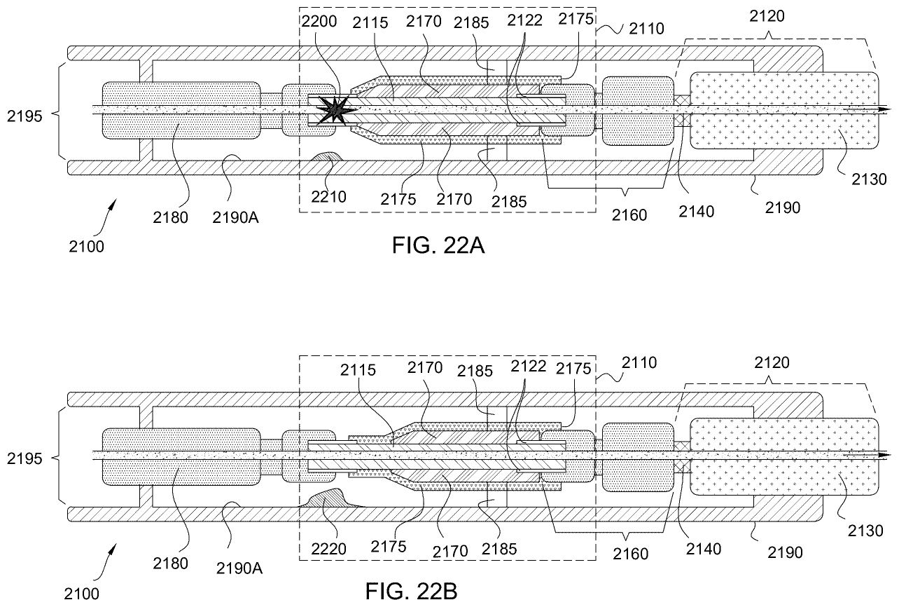

A layer of meltable or shrinkable sheath (e.g., shrink wrap, shrink tube) 2175 may surround the thermal fuse 2170. In the event of overheating (such as when the temperature approaches the melting temperature) and/or an arcing event, the meltable and/or shrinkable sheath may deform and or melt, thereby breaking the thermal fuse, as will be described below with reference to FIGS. 22A and 22B. The sheath 2175 is a contracting sleeve that shrinks or melts as a result of heat and may include a non-conducting substrate (e.g., a hollow tube). The contraction (e.g., by shrinking or melting) of the sheath 2175 breaks an electrical connection in the thermal fuse 2170 by pushing melted material away, as will be described below. This mechanical action of the sheath 2175 breaks any electric connection present in molten liquid material (e.g., a melted conductive alloy). A washer 2185, which may be formed of silicon or another appropriate material, which may be one or both of an electrically nonconductive material and a heat resistant material may be disposed perpendicularly to the layer of meltable and/or shrinkable sheath 2175 within the connector 2100, and substantially filling a space between two opposing sides of the conductor housing 2190. In the event of arcing, the washer may prevent the arc from spreading from one end of the connector 2100 to the other end of the connector 2100.

The sheath 2175 may comprise: an elastomeric sheath which contracts at a contraction temperature over 150° C.; a polyolefin sheath which contracts at a contraction temperature over 135° C.; a silicone rubber sheath which contracts at a contraction temperature over 200° C.; a polytetrafluoroethylene sheath which contracts at a contraction temperature over 175° C., or a sheath 2175 of another appropriate material. Typically, sheath 2175 may be selected so that contraction temperature of the sheath 2175 is less than a melting temperature of the thermal fuse. By way of an example, the sheath 2175 may contract at a temperature 20° C. lower (or more) than the melting point of the electrically conductive material (e.g., a fusible alloy, as discussed below).

The core 2115, the copper layer 2122, conducting portion 2170, layer of meltable and/or shrinkable sheath 2175, and the washer 2185 may form and be referred to herein as a “thermal fuse assembly” 2110. In some implementations of the thermal fuse assembly 2110, the washer may be absent.

Reference is now made to FIGS. 22A and 22B. FIG. 22A shows the thermal fuse of FIG. 21 during an example overheating (e.g., due to electrical arcing) event. FIG. 22B shows the thermal fuse of FIG. 22A after the example overheating event. A damaged electrical conduction path (e.g., due to corroded contact, moisture, dirt ingress, etc.) may result in an elevated temperature in connector 2100. In some cases, an arc 2200 which may occur across the connector 2100 may result in an elevated temperature. An electric arc, such as the arc 2200, typically has a very high current density. Electrical resistance along the arc 2200 creates heat, which typically ionizes gas molecules (where the degree of ionization is determined by temperature of the arc 2200). In order to prevent a failure resulting from the arc 2200, a fuse assembly 2110, which may comprise the conducting portion 2170 with lower melting temperature, may be provided within the connector 2100 in order to break the electric circuit as a result of the elevated temperature caused by the electric arc 2200.

As the arc 2200 (or other example overheating event) raises the temperature within the connector, the low melting temperature conducting material 2170 may deform or begin to melt (as was noted above, with reference to FIG. 16, the thermal fuse may comprise a metal or an alloy (e.g., the low melting temperature conducting material 2170) having a melting point between 50° C.-300° C. (for example a fusible alloy may having a melting point between 150° C. and 200° C.). In some examples, the alloy may have perforations. As the alloy melts, the molten alloy 2210 may drip or flow onto the inside wall 2190 of the connector 2100. The elevated temperature may also cause the meltable and/or shrinkable sheath 2175 to shrink or melt in the area from which the alloy flowed, thus insulating 2122 from the un-melted portion of the low melting temperature conducting material 2170. As the alloy melts, the conduction path 2199 no longer remains in place, which may lead, in turn to the arc dissipating. As the arc dissipates, the temperature may drop, and the molten allow 2210 which dripped onto the inside wall 2190 of the connector 2100 may resolidify, leaving a slab 2220 of the molten alloy adhering to the inside wall 2190 of the connector.

Reference is now made to FIGS. 23A and 23B, which show another example of connecting a thermal fuse assembly 2310 inside a connector 2300. The connector 2300 may be the same as or similar to the connector assembly 1600 of FIG. 16, the metal blank 1820 of FIG. 18, and the connector 2100 of FIG. 21. As discussed above with reference to FIG. 18, the connector 2300 may require folding in order to form a completed connector 2300, which may more closely resemble the connector 2100 (by way of example) of FIG. 21.

A metallic pin 2380, which may be similar to connector pin 1680 of FIG. 16 is disposed at one end of a window, formed by frame 2378. A first pin 2379A and a second pin 2379B may connect the thermal fuse assembly 2310 within the window, formed by frame 2378 inside the connector 2300. A crimp 2360 is at the second end of the connector 2300. The thermal fuse assembly 2310 may generally correspond to the portions 2110 of FIG. 21 disposed between the connector pin 2180 and the crimp 2160 of FIG. 21. After assembly, the frame 2378 may be removed, leaving the thermal fuse assembly as the only conducting path between connector pin 2380 and crimp 2360.

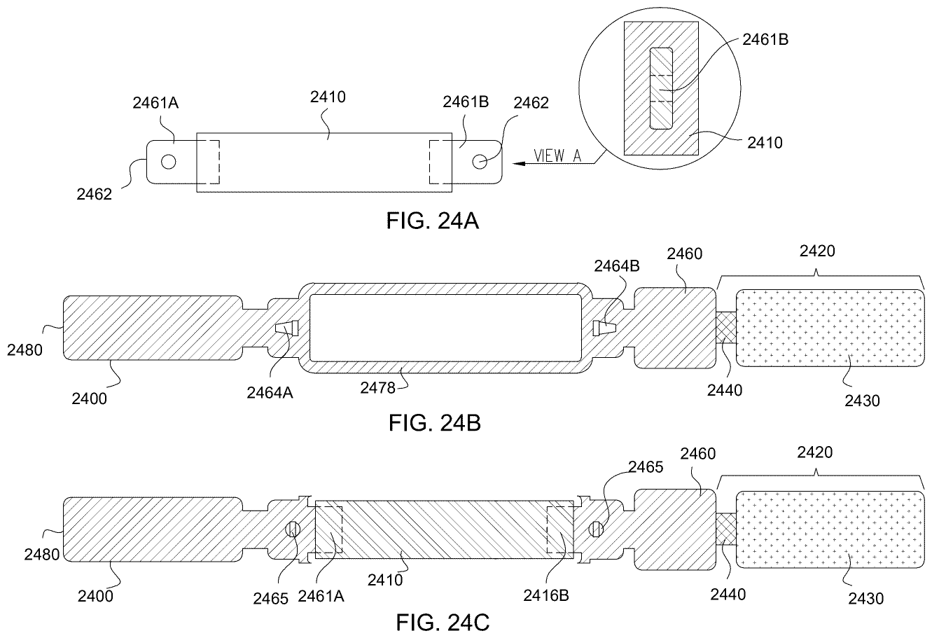

Reference is now made to FIGS. 24A-24C, which show another example of connecting a thermal fuse assembly 2410 within a connector 2400. FIG. 24A shows thermal fuse assembly 2410 with a left joint 2461A and a right joint 2461B. The left joint 2461A and the right joint 2461B may be fashioned out of tinned copper, or other appropriate metals. View A provides a side view of the thermal fuse assembly 2410 and right joint 2461B. The left joint 2461A and the right joint 2461B may each have a hole 2462 which may be used in forming a connection between the thermal fuse assembly 2410 and the connector 2400. Connector 2400 (FIGS. 24B and 24C) may be the same as or similar to the connector assembly 1600 of FIG. 16 the metal blank 1820 of FIG. 18, the connector 2100 of FIG. 21, and connector 2300 of FIG. 23. The thermal fuse assembly 2410 may be the same as or similar to the thermal fuse 1900 of FIGS. 19 and 20A-20C, the thermal fuse assembly 2110, and other thermal fuse described herein above. The connector 2400 may have, at a first end, a crimp 2460. Crimp 2460 may be the same as or similar to the crimp 1660 of FIG. 16, crimp 1830B of FIG. 18, crimp 2160 of FIG. 21, crimp 2360 of FIG. 23, and other crimps described herein. The connector 2400 may have, at a second end, a connector pin 2480. Connector pin 2480 may be the same as or similar to connector pin 1680 of FIG. 16, the connector pin 1820 of FIG. 18, and/or other connector pins described herein above. A cable 2420 an insulating layer 2430 on the outside of the cable 2420 and a length 2440 of conducting material inside the insulating layer 2430 may be connected to connector 2400 via crimp 2460 as described above with respect to FIGS. 16, 17, 21, and 23.

A window, formed by frame 2478, may be situated in the connector 2400. The thermal fuse assembly 2410 may be inserted in the window formed by the frame 2478 and generally connected to the assembly at 2480 by the left joint 2461A and at 2460 by the right joint 2461B. A pin 2464A and a pin 2464B or other extrusion from the connector 2400 may be inserted in the holes 2462. A press fit connection 2465 may be formed by applying pressure to the pin 2464A and the pin 2464B or other tab/extrusion from the connector 2400. The pins can be sealed or bent into place in the holes 2462, forming a press fit connection 2465. After assembly, the frame 2478 may be removed, leaving the thermal fuse assembly as the only conducting path between connector pin 2480 and crimp 2460.

Reference is now made to FIG. 25A which shows another example of connecting the thermal fuse assembly 2510 inside a connector 2500. The connector 2500 may be the same or similar to the connector assembly 1600 of FIG. 16, the metal blank 1820 of FIG. 18, and the connector 2100 of FIG. 21, the connector 2300, and other connectors described herein. The thermal fuse assembly 2510 may be the same as or similar to the thermal fuse 1670 of FIG. 16, thermal fuse 1900 of FIGS. 19 and 20, the thermal fuse assembly 2110 of FIG. 21, the thermal fuse assembly 2310 of FIG. 23, the thermal fuse assembly 2410 of FIG. 24, and other thermal fuses described herein.

A cable 2520, typically comprising an insulating layer 2530 on the outside of the cable 2520 and a length 2540 of conducting material inside the insulating layer 2530 may enter the of the connector 2500 at a first end. The cable 2520, the insulating layer 2530 and the length 2540 of conducting material may be the same as or similar to the cable 1620, the insulating layer 1630 and the length 1640 of conducting material of FIG. 16, or other cables, insulating layers, and lengths of conducting material described herein. A crimp 2560, which may be the same as or similar to the crimp 1660 of FIG. 16 or other crimps described herein is attached, at a first end, to the length 2540 of conducting material. The crimp 2560 may be attached at a second end to the thermal fuse assembly 2510.

The connector 2500 may have, at a second end, a connector pin 2580, which may be the same as or similar to connector pin 1680 of FIG. 16, the connector pin 1820 of FIG. 18, and other connector pins described herein above. A window, formed by frame 2578, may be situated in the connector 2500. The thermal fuse assembly 2510 may be inserted in the window formed by the frame 2578 and attached to terminals 2579A, 2579B. Terminals 2579A, 2579B extend from within the thermal fuse assembly 2510 to the connector 2500 at terminals 2575A, 2575B. Terminals 2575A, 2575B may be welded, for example, by using resistance welding at two or more welding points 2573A, 2573B on each of terminals 2575A, 2575B.

Resistance welding may be used to join metals by applying pressure and passing current for a length of time through the metal area which is to be joined. When using resistance welding, typically, no other materials are needed to create a bond between the terminals 2575A, 2575B and the connector 2500. After assembly, the frame 2578 may be removed, leaving the thermal fuse assembly as the only conducting path between connector pin 2580 and crimp 2560.

In addition to the techniques for connecting the thermal fuse assembly 2310, 2410, 2510 inside the connector 2300, 2400, 2500 mentioned above with reference to FIGS. 23A-25, the thermal fuse assembly 2310, 2410, 2510 may also be connected inside the connector 2300, 2400, 2500 using friction welding, soldering, ultrasonic welding, brazing, magnetic pulse welding, crimping, and magnetic pulse crimping. The above list and descriptions are provided by way of example, and not intended to be limiting.

Reference is now made to FIGS. 25B-25G. The connector 2500 having the a connector pin 2580, as well as the cable 2520, the insulating layer 2530 and the length 2540 of conducting material and the crimp 2560 are all present in FIGS. 25B-25G. The connector 2500 having the a connector pin 2580, as well as the cable 2520, the insulating layer 2530 and the length 2540 of conducting material, the crimp 2560, and the frame 2578 for the sake of brevity, will not be discussed, but rather, the description above, with reference to FIG. 25A is relied upon.

Turning specifically to FIGS. 25B and 25C, FIG. 25B shows a first spring based thermal fuse assembly in a closed state, and FIG. 25C shows the first spring based thermal fuse assembly in an open state. A first conducting element 2532 (for instance a copper, aluminum wire) may extend from the connector 2500. A second conducting element 2534 (which may also be a copper or an aluminum wire) extends from the crimp 2560. A spring 2536, for example a leaf spring, also referred to as a semi-elliptical or elliptical spring, which may be a slender arc-shaped length of spring material (for instance, a low-alloy manganese, medium-carbon steel or high-carbon steel with a very high yield strength), overlays a first side of the second conducting element 2534 in a primed (e.g., storing potential energy) state. The first conducting element 2532 and the second conducting element 2534 may be connected by a low melting temperature alloy 2538 (which may be the same or similar to the low melting temperature alloy 2170 of FIG. 21). Current may flow between the first conducting element 2532 and the second conducting element 2534 as long as the low melting temperature alloy 2538 is present. Should the low melting temperature alloy 2538 melt, for instance, in the event of an arcing event during which the temperature rises above the melting point of the low melting temperature alloy 2538, the spring may be released (returning to an undeformed state), and the first conducting element 2532 and the second conducting element 2534 may no longer be connected, as depicted in FIG. 25C.

Turning specifically to FIGS. 25D and 25E, FIG. 25D shows a second spring based thermal fuse assembly in a closed state. Specifically, a helical spring 2541A may connect between the connector 2500 and the crimp 2560. A first conducting element 2542 may be present at a terminus of the connector 2500. The first conducting element 2542 may be connected to a low melting temperature alloy 2548, which may be the same as or similar to the low melting temperature alloy 2538 of FIGS. 25B and 25C, and the low melting temperature alloy 2170 of FIG. 21. The low melting temperature alloy 2538 may be connected, on a second side, to a terminus 2546 of the helical spring 2541A. At a second side, the helical spring 2541A may be connected to a second conducting element 2544, which may be the same as or similar to second conducting element 2544. Should the low melting temperature alloy 2548 melt, for instance, in the event of an arcing event during which the temperature rises above the melting point of the low melting temperature alloy 2548, the spring 2541A may be released, contract, as depicted by spring 2541B in FIG. 25E.

Turning now to FIGS. 25F and 25G, FIG. 25F shows a third spring based thermal fuse assembly in a closed state. Specifically, a first conducting element 2552 (for instance a copper, aluminum wire) may extend from the connector 250. The first conducting element 2552 may terminate at a low melting point alloy terminus 2558. A second conducting element 2554 may be connected to the terminus 2558 at one side, and may be held by current carrying wings 2562A, 2562B at a second side. A spring, which might be, for example, as stainless steel or other appropriate material spring 2561A may be disposed between the second conducting element 2554 at one side and the crimp 2560 at the second side, and surrounded by the current carrying wings 2562A, 2562B. Should the low melting temperature alloy 2558 melt, for instance, in the event of an arcing event during which the temperature rises above the melting point of the low melting temperature alloy 2558, the spring 2561 may then contract, as depicted by spring 2561B in FIG. 25G. In such a case a gap 2569 is effectively created between the first conducting element 2552 and the second conducting element 2554. An example of how electrical current may flow through the connector is provided in FIG. 25F by dashed arrow 2564.

Turning now to FIGS. 25H and 25I, FIG. 25H shows a fourth spring based thermal fuse assembly in a closed state. Specifically, a first conducting element 1552A (for instance a copper, aluminum wire) may extend from the connector 2500. The first conducting element 2552A may terminate at a low melting point alloy terminus 2558. A second conducting element 2552B (for instance a copper, aluminum wire) may be connected to the terminus 2558 at one side, and may be held by a spring 2571A at a second side. The second conducting element 2552B may be connected to a first end of a conducting wire 2577 (which may, for example, a copper or aluminum wire) at one end. At a second end, the conducting wire 2577 may be connected to length 2540 of conducting material via the crimp 2560. Should the low melting temperature alloy 2558 melt, for instance, in the event of an arcing event during which the temperature rises above the melting point of the low melting temperature alloy 2558, the spring 2571A may then contract, as depicted by spring 2571B in FIG. 25I. In such a case, the second conducting element 2552B is drawn away from the first conduction element 2552A as the spring 2571B retracts. A conducting path is thereby broken when the conducting wire 2577, which is attached to the second conducting element 2552B is drawn away with the second conducting element 2552B.

Turning now to FIGS. 25J and 25K, FIG. 25H shows a fifth spring based thermal fuse assembly in a closed state. Specifically, a first conducting element 2552 (for instance a copper, aluminum wire) may be attached to the connector 2500 via a first frame formed of at least one second conducting element 2565A, 2565B (for instance a copper, aluminum wire). The first conducting element 2552 may be attached to the at least one second conducting element 2565A, 2565B by a low melting temperature alloy 2568. A second frame formed of at least one second conducting element 2565C, 2565D (for instance a copper, aluminum wire) may be attached at a second end of the first conducting element 2552. The first conducting element 2552 may be further be connected to a spring 2581A. Should the low melting temperature alloy 2568 melt, for instance, in the event of an arcing event during which the temperature rises above the melting point of the low melting temperature alloy 2568, the spring 2581A may then contract, as depicted by spring 2581B in FIG. 25K.

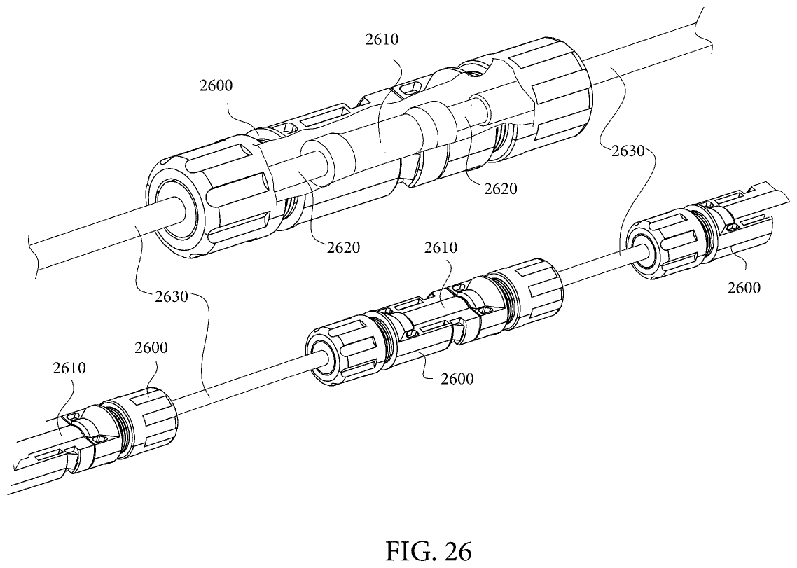

Reference is now made to FIG. 26, which shows the thermal fuse in a connector, for example, in a photovoltaic energy system. It is appreciated that FIG. 26 and other figures in the present disclosure may not be drawn to scale. A connector 2600 is seen with a cut away portion of the depiction of the connector. A thermal fuse assembly 2610 is seen within the connector 2600. An electrical cable 2620 connects between the thermal fuse assembly 2610 inside the connector 2600 and a second electrical cable 2630 outside the connector 2600. The second electrical cable 2630 extends to a second connector 2600. Thermal fuse assembly 2610 and connector 2600 may be an example of any of the thermal fuses, thermal fuse assemblies, and connectors described above.

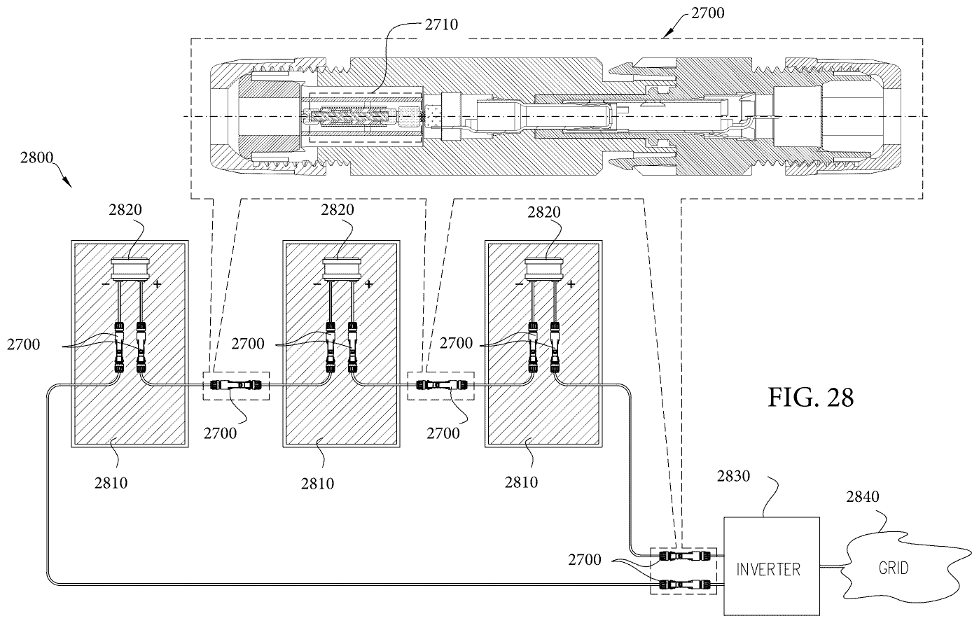

The thermal fuse, when used, for example in a photovoltaic system (as will be discussed below, with reference to FIG. 28) may be used to form a connection with a cable at an output of a solar panel, an output of a device which performs module level power electronics (such as micro-inverters and power optimizers) which may be installed in solar panel systems in order to improve performance and safety of the solar panels. The thermal fuse disposed in the connector may be disposed between panels and/or between a single panel or a string of panels and a DC/DC converter or a DC/AC inverter.

The thermal fuse may be disposed in a connector which may then be fitted into cables used in new solar panel installations or retro-fitted into existing solar panel installations.

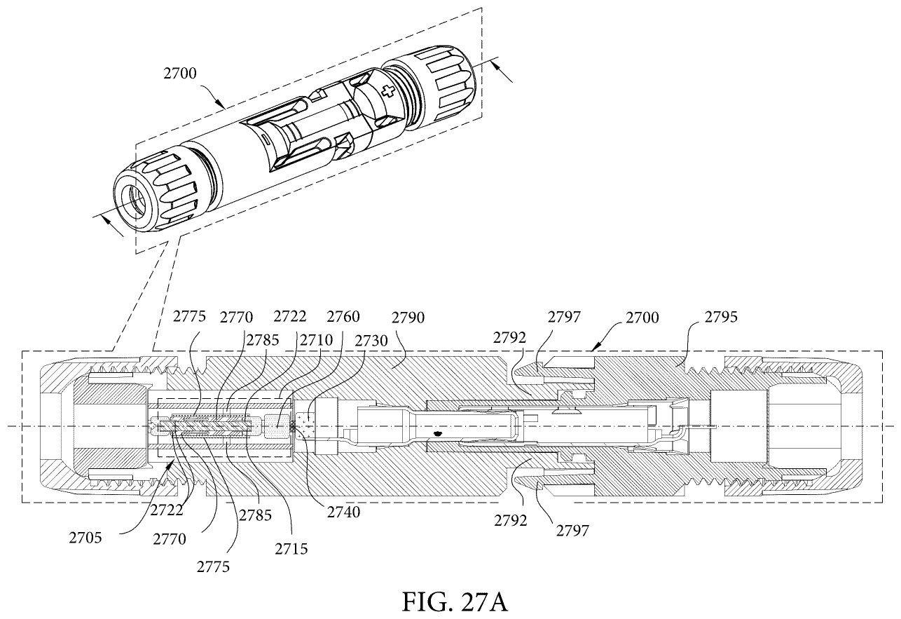

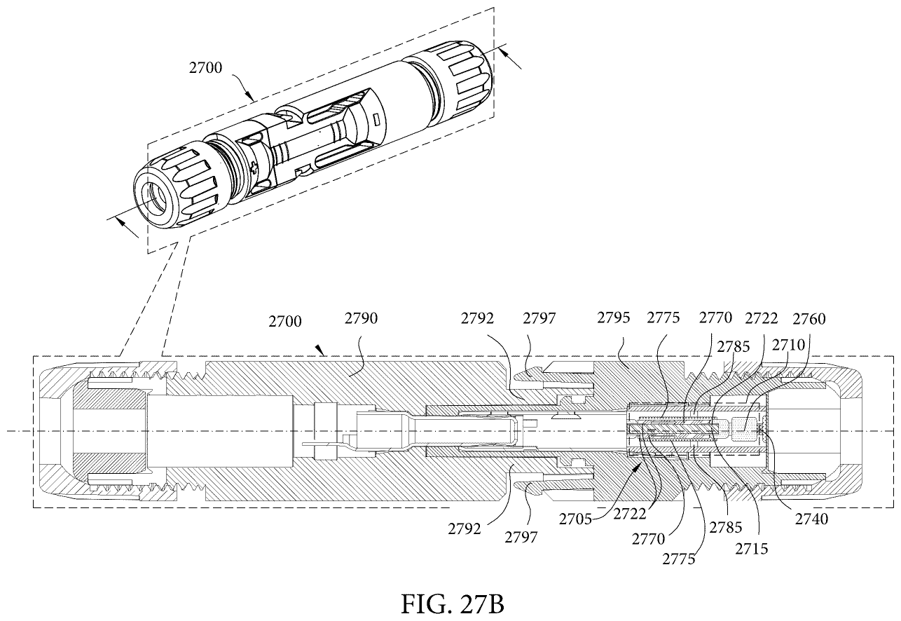

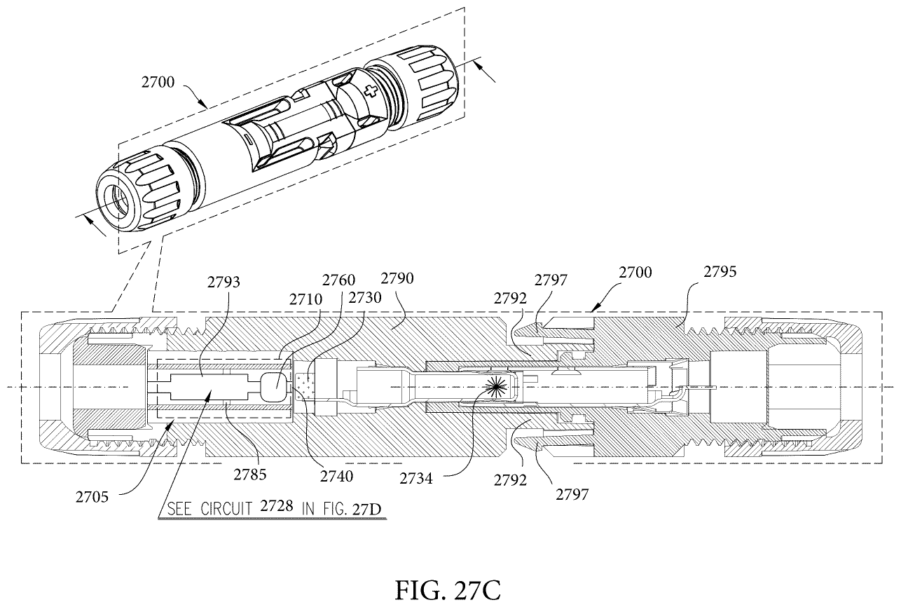

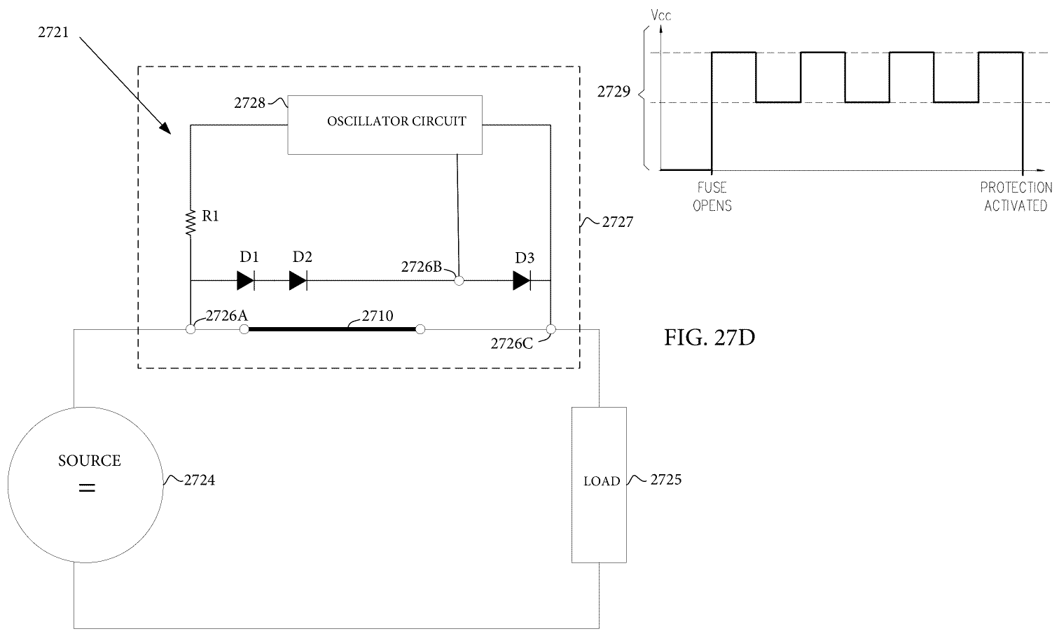

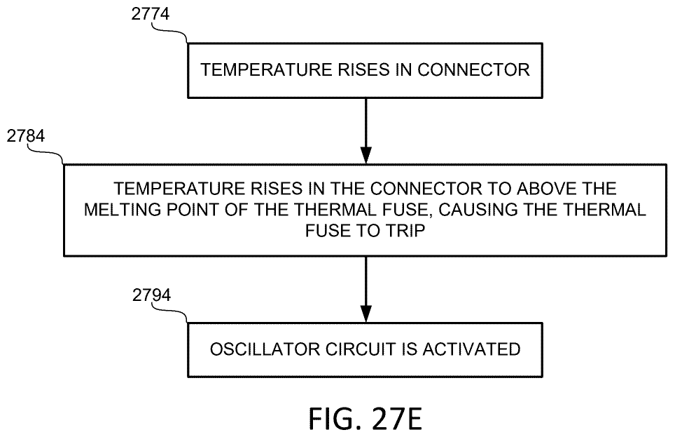

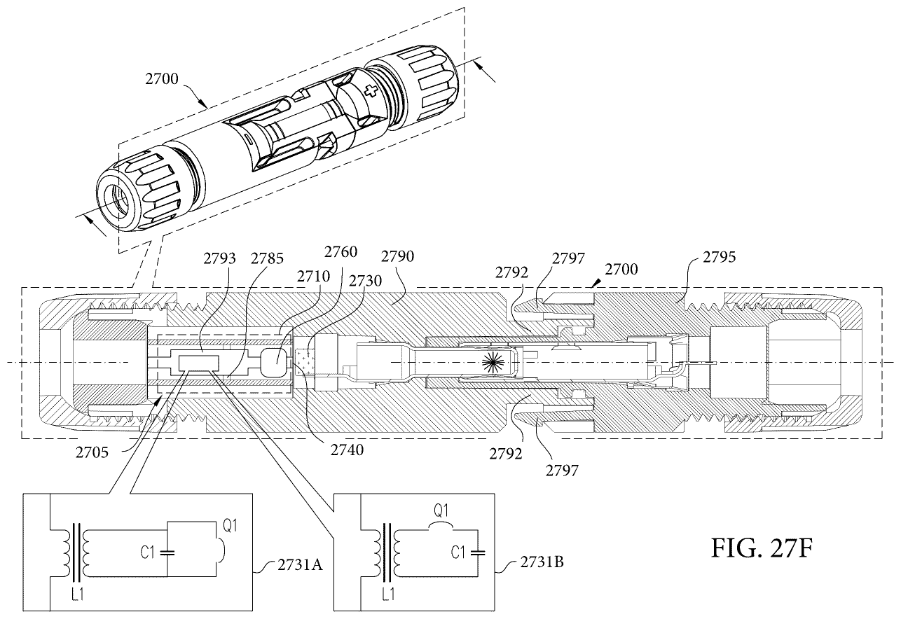

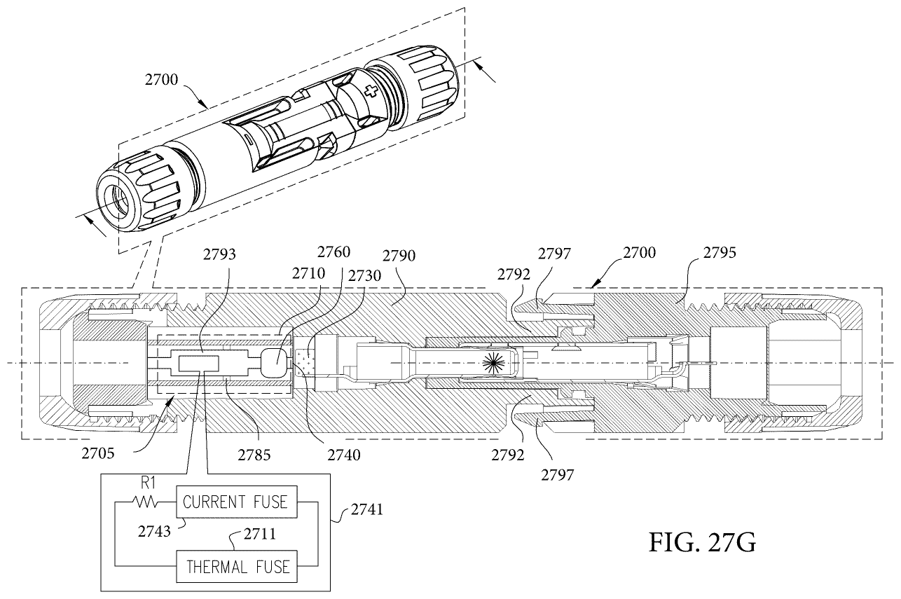

Reference is now made to FIG. 27A, which shows the thermal fuse assembly in a plug portion 2790, which connected to a socket portion 2795, of the connector 2700, for example, in a photovoltaic energy system. The thermal fuse assembly 2710 may be the same as or similar to the first thermal fuse 1670 of FIG. 16, the thermal fuse 1900 of FIGS. 19 and 20A-20C, and the thermal fuse assembly 2110 of FIG. 21, as well as other thermal fuse assemblies described herein above. The connector plug portion 2790 may be similar to or the same as the connector 1600 of FIG. 16, connector 2100 of FIG. 21, as well as other connectors described herein above. The connector 2700 comprises two parts, a plug part 2790 which may snap, for example, using connector pins 2792, into a socket part 2795. Connector pins 2792 may connect to corresponding receiving portion 2797 in the socket part 2795.

Reference is now made to FIG. 27B, which shows the thermal fuse assembly 2710 in a socket portion 2795 of the connector 2700, for example, in a photovoltaic energy system. The connector 2700 of FIGS. 27A and 27B may be the same or similar, except for the disposition of the thermal fuse assembly 2710. As noted above, the thermal fuse assembly 2710 may be disposed in the plug portion 2790 of the connector 2700 of FIG. 27A. The thermal fuse 2710 may be disposed in the plug portion 2795 of the connector 2700 of FIG. 27B.

The thermal fuse assembly 2710 may be the same or similar to the thermal fuse assembly 2110 described above with reference to FIG. 21. The thermal fuse assembly 2710 may comprise elements which may be the same as or similar to the elements described in the thermal fuse assembly 2110 of FIG. 21. By way of example, a length 2740 of conducting material may be the same or similar to the length 2140 of conducting material of FIG. 21. A crimp 2760 may be the same or similar to the crimp 2160 of FIG. 21; a core 2715 may the same or similar to the core 2115 of FIG. 21; a copper layer 2722, may the same or similar to the copper layer 21222 of FIG. 21; a conducting portion 2770 may be the same or similar to the conducting portion 2170 of FIG. 21; a layer of meltable and/or shrinkable sheath 2775 may be the same as or similar to the layer of shrink wrap 2176; and a washer 2785 may be the same as or similar to the washer 2185 of FIG. 21. Other elements of the thermal fuse assembly 2120 described above with reference to FIG. 21 may not be depicted in FIGS. 27A and 27B, but may be present in an implementation of the connector 2700 described here. The description is meant to be non-limiting.

Reference is now made to FIG. 27C, which show a circuit 2793 disposed in the connector and acting as the thermal fuse 2710. For convenience, the circuit 2793 is depicted in the plug portion 2790, similar to the depiction in FIG. 27A. It is appreciated that the circuit 2793 may be disposed in the socket portion 2795, as in FIG. 27B. The washer 2785, the copper layer 2722, the conducting portion 2770, and the shrinkable sheath 2775 may be supplemented by the circuit 2793 which is configured to send a signal (e.g., an alarm) to an external device, such as a server (not depicted) or an inverter (such as inverter 2830, described below, with reference to FIG. 28) if the fuse is broken (e.g., blown). If temperature rises in the connector 2700, for example at a junction between the plug portion 2790 and the socket portion 2795, indicated by a star 2734, for instance, the thermal fuse 2710 may open, and the circuit 2793 may then send a signal to the external device. The circuit 2793 may, for example, generally be disposed in the area where the spring 2536, 2541A, 2541B, 2561A, 2561B, 2571A, 2571B, 2581A, 2581B is disposed, as described above, with reference to FIGS. 25B-25K. It is appreciated that the spring 2536, 2541A, 2541B, 2561A, 2561B, 2571A, 2571B, 2581A, 2581B is featured in the apparatus depicted in FIG. 27C. Other springs may be utilized.

Reference is now made to FIG. 27D, which shows an example of an alarm circuit 2721 which may comprise an oscillator circuit 2728. The alarm circuit 2721 may be disposed in parallel to the thermal fuse 2710, connecting to the thermal fuse 2710 at nodes 2726A and 2726C, for example. The alarm circuit 2721 may be disposed inside of a connector 2727. The connector 2727 may be the same as or similar to connector 2700 described above, and correspondingly, may be similar to or the same as the connector 1600 of FIG. 16, connector 2100 of FIG. 21, as well as other connectors described herein above. The connector may be disposed between a source 2724 and a load 2725. By way of example, the source 2724 may be a source of DC electricity, such as, and without limiting the generality of the foregoing, a photovoltaic panel and/or a power optimizer. The load 2725 may comprise, by way of example, a DC/AC inverter, a second power optimizer, or other appropriate power electronic device.

As long as the thermal fuse 2710 remains closed (e.g., not blown), current from the source 2724 flows through the thermal fuse 2710 to the load 2725. When the thermal fuse 2710 is open (e.g., blown), for example, due to the thermal fuse 2710 melting, as described above, current bypasses the now open thermal fuse 2710, and flows into diodes D1 and D2. It is noted that in some implementations, only one diode, for example D1 may be present. Resistor R1 is disposed between node 2726A and the oscillator circuit 2728. Most of the current flows through the diodes D1, D2, and D3 due to the presence of resistor R1. A small amount of current will, however, enter the oscillator circuit 2728 via resistor R1. The oscillator circuit 2728 (described below) may produce an output which oscillates between two values, as depicted by graph 2729. By way of example, if there are two diodes D1 and D2, as depicted, each diode will have a voltage drop of around 600 mV, then the two diodes D1 and D2 will combine to provide a 1200 mV voltage drop. If there is only one diode, D1, then the voltage drop will be around 600 mV.

The oscillator circuit may include a switch disposed between node 2726A and node 2726B. The switch may be controlled to open and close as the oscillator circuit 2728 oscillates, which may be detected as a notification of the open fuse. The switch may comprise a metal oxide semiconductor field-effect transistor (MOSFET), a bipolar junction transistor (BJT), or an insulated-gate bipolar transistor (IGBT) or other appropriate switch. When the switch is open, current flows though the diodes D1 and D2. When the switch is closed, the oscillator circuit 2728 provides a bypass current path via node 2726B. When the switch is open, current bypasses the diodes D1 and D2 and D3, and flows through the oscillator circuit 2728 to node 2726C. The load 2725, e.g., the DC/AC inverter, may detect the oscillation and activate protection. For example the DC/AC inverter may send a command to source 2724 requesting shut down production of DC electricity from the source 2724. The DC/AC inverter may also notify a remote server of the malfunction.

The oscillator circuit 2728 may comprise an oscillator crystal, which may be disposed, for example, on a chipset. For example, the chipset may comprise a 32.768 KHz oscillating crystal. Chipsets comprising crystals which oscillate between 32 KHz-1075.804 MHz may also be used, by way of example, depending on design and implementation. The various frequencies of crystal oscillators mentioned herein are by way of example, and not in a limiting fashion. Other appropriate chipsets at other oscillation frequencies may be used as well.

The operation of the bypass alarm circuit 2721 is now described with additional reference to FIG. 27E. At step 2774, the temperature rises in the connector 2700, such as may occur during an arcing event. At step 2784, the temperature rises in the connector 2700 to above the melting point of the thermal fuse 2710, causing the thermal fuse to open, when the low melting metal portion of the fuse melts, thereby breaking a current path through the circuit. The current path into the alarm circuit 2721 has a higher resistance than the current path into the thermal fuse 2710. As long as the thermal fuse 2710 is closed (e.g., not blown), current will flow through the thermal fuse 2710, and not into the oscillator circuit 2728. When the thermal fuse 2710 is blown, the current will flow through the bypass circuit. At step 2794 the bypass circuit is activated. An AC current oscillates at the frequency of the crystal of the oscillator circuit 2728 in the alarm circuit 2721. When the inverter (such as inverter 2830, described below, with reference to FIG. 28) detects the oscillating AC current, the inverter may shut down operation of an effected string of solar panels.

FIG. 27F shows an example of an inductor circuit 2731A, 2731B which may be disposed in parallel to the thermal fuse, instead of the oscillator circuit described above. The inductor circuit 2731A, 2731B may be disposed in the connector in parallel to thermal fuse (depicted here as Q1). Inductor circuit 2731A and inductor circuit 2731B are two non-limiting examples of options for implementing the inductor circuit. When the thermal fuse is closed (unblown), the inductor circuit 2731A, 2731B is shorted. If the thermal fuse opens (is blown), then the inductor circuit 2731A, 2731B is no longer shorted.

Inductor circuit 2731A comprises inductor L1 in parallel to a capacitor C1 and the thermal fuse Q1. When the thermal fuse Q1 is blown, the inductor L1 increases impedance, and the capacitor C1 and inductor L1 combine forming a resonant circuit. As the circuit resonates a signal may thereby be created, in accordance with the properties of the resonant circuit. The signal may provide an indication to an inverter, (such as inverter 2830, described below, with reference to FIG. 18) that the thermal fuse 2710 is open. The inverter may then perform steps to shut down operation of affected photovoltaic panels, as well as notify a remote server of the malfunction.

Inductor circuit 2731B may be utilized instead of inductor circuit 2731A. Inductor circuit 2731B comprises the inductor L1 in series with the thermal fuse Q1 and capacitor C1. The thermal fuse Q1 may be disposed between the inductor L1 and the capacitor C1. The capacitor C1 and inductor L1 combine forming a resonant circuit. The inductor L1 may build inductance. A signal created by the resonance of the circuit may indicate to the inverter that the thermal fuse Q1 is not blown. Should the thermal fuse Q1 be blown the resonant circuit is now open, and no signal is provided to the inverter. The inverter may then perform steps to cease operation, such as using a rapid shutdown device or optimizer of the affected photovoltaic panels, as well as notify a remote server of the malfunction.

Reference is now made to FIG. 27G which shows another aspect 2741 which may be implemented in the thermal fuse described herein. The thermal fuse 2710 may be placed in parallel to a current-limiting fuse. If the thermal fuse melts, a current-limiting fuse 2743 is able to provide a bypass (e.g., to allow a waveform, as described above, to bypass the thermal fuse 2710, to provide an alarm indicating to the inverter (such as inverter 2830, described below, with reference to FIG. 28) that the thermal fuse 2710 is open. The inverter may then perform steps to shut down operation of affected photovoltaic panels, and/or notify a remote server of the malfunction. It is appreciated that variations in the circuitry of FIG. 27G may result in variant wave forms of the signal, such as sine waves or triangular waves instead of the square wave depicted.

FIG. 28 shows several examples of use of the connector 2700 comprising the thermal fuse assembly 2710 in a photovoltaic energy system 2800. The photovoltaic energy system 2800 may comprise at least one solar panel 2810. The at least one solar panel 2810 may have an output interface 2820 from which the at least one solar panel 2810 may output electricity, for example as DC electricity. The output interface 2820 may be an output from a device which performs module level power electronics (such as micro-inverters and power optimizers) which may be installed in the photovoltaic energy system 2800 in order to improve performance of the solar panels 2810. Connections between the output interface 2820 of one of the at least one solar panel 2810 and a second one of the at least one solar panel 2810 may be formed using the connector 2700. A circuit of a series string (by way of example) of a plurality of the at least one solar panel 2810 may connect, via one or more of the connectors 2700 to an inverter 2830, which my, for example, comprise a DC/AC inverter or a DC/DC converter. The inverter 2830 may, by way of example, provide AC electricity to an electric grid 2840. In some implementations, DC electricity may be stored in a battery (not depicted) which may itself be connected to the inverter 2800, a separate DC/DC converter (not depicted), or so forth, with the connector 2700.

It is noted that various connections are set forth between elements herein. These connections are described in general and, unless specified otherwise, may be direct or indirect; this specification is not intended to be limiting in this respect. Further, elements of one embodiment may be combined with elements from other embodiments in appropriate combinations or subcombinations. For example, integrated cable 800 of FIG. 8A may be used as an output conductor 404a of power device 400 or as output conductor 604a of PV panel 610. As another example, the architecture illustrated in FIG. 11 and described with regard to the method of FIG. 10 may also be used to implement all or part of the method of FIG. 1. As another example, a power device may comprise one or more thermal fuses integrated into one or more power device connectors (e.g., as shown in FIG. 14), and may additionally comprise one or more thermal sensors disposed in proximity to the connectors, as shown in FIG. 2. The power device may be configured to provide a first level of protection by reducing power drawn at the input connectors in response to detecting an overheating condition, and the integrated fuses may provide a second level of protection in case the first level of protection does not provide a sufficient response.

1. An apparatus comprising:
an electronic circuit disposed in an enclosure, the electronic circuit configured to draw power from a power source;
a first connector disposed externally to the enclosure wherein the first connector is coupled to the electronic circuit via a first conductor;
a second connector disposed externally to the enclosure, wherein the second connector is coupled to the electronic circuit via a second conductor;
a first temperature sensing device configured to sense a temperature related to the first connector; and
a controller configured to:
receive a first measurement from the first temperature sensing device,
determine, based on the first measurement, an overheating condition of the first connector, and
initiate an overheating response based on the first measurement indicating overheating.

2. The apparatus of claim 1, wherein the first temperature sensing device is configured to sense a temperature related to the second connector.

3. The apparatus of claim 1, further comprising:
a third connector disposed externally to the enclosure, wherein the third connector is coupled to the electronic circuit via a third conductor,
a second temperature sensing device configured to sense a temperature at the third connector,
wherein the controller is further configured to:
receive a second measurement from the second temperature sensing device,
determine, based on the second measurement, an overheating condition of the third connector, and
initiate an overheating response based on the second measurement indicating overheating.

4. The apparatus of claim 1, further comprising a current sensor configured to measure a current in the electronic circuit and provide one or more current measurements to the controller.

5. The apparatus of claim 4, wherein the controller is configured to initiate an overheating response based on the first measurement and the one or more current measurements indicating an overheating condition.

6. The apparatus of claim 1, wherein the electronic circuit comprises a DC/DC converter or a DC/AC converter.

7. The apparatus of claim 1, wherein the overheating response comprises reducing power output by the electronic circuit.

8. The apparatus of claim 1, wherein the overheating response comprises reducing voltage output by the electronic circuit.

9. A method comprising:
receiving a first temperature measurement from a first temperature sensing device, wherein the first temperature measurement is related to a first connector disposed externally to an enclosure;
determining, based on the first temperature measurement, an overheating condition of the first connector; and
initiating an overheating response based on the determining an overheating condition of the first connector.

10. The method of claim 9, further comprising:
receiving a second temperature measurement from a second temperature sensing device, wherein the second temperature measurement is related to a second connector disposed externally to the enclosure;
determining, based on the first temperature measurement and the second temperature measurement, an overheating condition of the first connector; and
initiating an overheating response based on the determining indicating overheating.

11. The method of claim 10, wherein determining, based on the first temperature measurement and the second temperature measurement, an overheating condition of the first connector, comprises comparing the first temperature measurement to the second temperature measurement.

12. The method of claim 9, further comprising:
receiving a second temperature measurement from the first temperature sensing device, the second temperature measurement obtained at a different time from the first temperature measurement;
determining, based on the first temperature measurement and the second temperature measurement, an overheating condition of the first connector; and
initiating an overheating response based on the determining indicating overheating.

13. The method of claim 9, wherein the determining, based on the first temperature measurement, an overheating condition of the first connector comprises comparing the first temperature measurement to a predicted temperature.

14. The method of claim 9, further comprising:
receiving a current measurement from a current sensor;
determining, based on the current measurement and the first temperature measurement, an overheating condition of the first connector; and
initiating an overheating response based on the determining indicating overheating.

15. The method of claim 9, further comprising transmitting a notification of an overheating condition to a system control device.

16. The method of claim 15, further comprising receiving, by the system control device, the notification of an overheating condition and determining, based on the notification, a safety condition of a system comprising the first temperature sensing device.

17. The method of claim 16, further comprising, based on determining that an unsafe condition is present in the system, disconnecting a portion of the system from an electrical current.

18. The method of claim 9, further comprising:
transmitting baseline temperature measurements to a system control device;
determining, based on the baseline temperature measurements, a baseline operating temperature; and
determining, based on the first temperature measurement and the baseline operating temperature, a safety condition of a system comprising the first temperature sensing device.

19. The method of claim 18, further comprising, based on determining that an unsafe condition is present in the system, disconnecting a portion of the system from an electrical current.

20. The method of claim 18, wherein determining, based on the first temperature measurement and the baseline operating temperature, a safety condition of a system comprising the first temperature sensing device comprises comparing the first temperature measurement to a predicted temperature value based on the baseline operating temperature and a current measurement received from a current sensor.
